(19) United States
(12) Patent Application Publication
(10) Pub. No.: US 2025/0277694 A1
(43) Pub. Date: Sep. 4, 2025

(54) VIBRATION SENSING APPARATUS

(71) Applicant: LG Display Co., Ltd., Seoul (KR)

(72) Inventors: Seung Hyeon KIM, Paju-si (KR); Tae Hyung KIM, Paju-si (KR); Hak Mo HWANG, Paju-si (KR); Min Ho SOHN, Paju-si (KR); Gyung Bo HA, Paju-si (KR)

(73) Assignee: LG Display Co., Ltd., Seoul (KR)

(21) Appl. No.: 19/057,648

(22) Filed: Feb. 19, 2025

(30) Foreign Application Priority Data
Feb. 29, 2024 (KR) 10-2024-0029913

(51) Int. Cl. G01H 11/08; G01H 13/00

(52) U.S. Cl. CPC G01H 11/08; G01H 13/00

(57) ABSTRACT

Embodiments disclose a vibration sensing apparatus including a base member, a vibration transmission member disposed on the base member, and a sensing element disposed on the vibration transmission member. The vibration transmission member is configured to transmit an external vibration signal to the sensing element.

### CROSS-REFERENCE TO RELATED APPLICATION

This application claims priority to and the benefit of Korean Patent Application No. 10-2024-0029913, filed Feb. 29, 2024 the disclosure of which is incorporated herein by reference in its entirety.

### BACKGROUND

### Technical Field

The present specification relates to a vibration sensing apparatus.

### Description of Related Art

A method of evaluating measurement targets, such as systems or structures, may involve attaching vibration sensors to the measurement targets and evaluating the measurement targets based on the frequency and acceleration of vibrations measured by the vibration sensors. The vibration sensors are mainly used as vibration sensors using piezoelectric materials capable of detecting the frequency and acceleration of vibrations

### BRIEF SUMMARY

Vibration sensors are classified by their usable frequency bands depending on their types, and different types of sensors are required to measure a wide range from a low frequency region to a high frequency region. There is also the problem of low sensitivity, as the target frequency suitable for the systems is not amplified.

One embodiment of the present specification provides a vibration sensing apparatus capable of measuring a wide frequency range from low to high frequency regions.

One embodiment of the present specification provides a vibration sensing apparatus with excellent sensitivity in a specific frequency region by amplifying at a target vibration frequency.

The problems to be solved by the present specification are not limited to those described above, and additional objects will become apparent to those skilled in the art from the following description.

A vibration sensing apparatus according to one embodiment of the present specification includes a base member, a vibration transmission member disposed on the base member, and a sensing element disposed on the vibration transmission member. The vibration transmission member transmits an external vibration signal to the sensing element.

Detailed items according to various examples of the present specification, other than the configuration described above are included in the following description and the accompanying drawings.

According to one embodiment of the present specification, vibrations may be measured in a wide frequency range from low to ultra-high frequency regions.

According to one embodiment of the present specification, sensitivity in a specific frequency region may be improved by adjusting the vibration frequency of the sensor to correspond to a target vibration frequency of the measurement target.

According to one embodiment of the present specification, it is possible to enable uni-materialization by forming the sensing element as a single component.

The effects of this specification are not limited to the foregoing effects and additional effects not mentioned herein will be apparent to those skilled in the art from the following description.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a view showing a vibration sensing apparatus according to a first embodiment of the present specification;

FIG. 2 is a plan view showing the vibration sensing apparatus according to the first embodiment of the present specification;

FIGS. 3A to 3C are diagrams showing the sensing voltage levels according to shapes of the vibration transmission member of the present specification;

FIG. 4 is a diagram showing various shapes of a coupling member according to an embodiment of the present specification;

FIGS. 5A to 5C are diagrams showing sensing ranges according to the shapes of the coupling members;

FIG. 6 is a diagram showing a vibration sensing apparatus according to a second embodiment of the present specification;

FIG. 7A is a diagram showing the sensing voltage levels of a plurality of sensing elements according to the embodiment of the present specification;

FIG. 7B is a diagram showing the sensing voltage levels of the vibration sensing apparatus according to the embodiment of the present specification;

FIG. 8 is a diagram showing various modified examples of the first vibration transmission member and the second vibration transmission member according to the embodiment of the present specification;

FIG. 9 is a diagram showing vent holes formed in the vibration sensing apparatus according to the second embodiment of the present specification;

FIG. 10 is a first modified example of FIG. 9;

FIG. 11 is a second modified example of FIG. 9;

FIG. 12 is a diagram showing a vibration sensing apparatus according to a third embodiment of the present specification;

FIGS. 13A and 13B are diagrams showing a vibration sensing apparatus according to a fourth embodiment of the present specification;

FIG. 13C is a modified example of FIG. 13A;

FIG. 14 is a diagram showing a vibration sensing apparatus according to one embodiment of the present specification;

FIG. 15 is a cross-sectional view taken along line I-I′ in FIG. 14 according to the embodiment of the present specification;

FIG. 16 is a cross-sectional view taken along line II-II′ in FIG. 14 according to the embodiment of the present specification;

FIG. 17 is a diagram showing a vibration sensing part according to another embodiment of the present specification;

FIG. 18 is a diagram showing a vibration sensing part according to another embodiment of the present specification;

FIG. 19 is a diagram showing a vibration sensing apparatus according to another embodiment of the present specification;

FIGS. 20A to 20D are views showing the sensing voltage characteristics according to a change in the shape of the base member of the present specification;

FIGS. 21A to 21E are views showing the sensing voltage characteristics according to a change in the shape of the base member in a structure in which the vibration transmission member is omitted;

FIGS. 22A to 22C are views showing the sensing voltage characteristics according to a change in the area of the base member of the present specification;

FIGS. 23A to 23D are views showing the sensing voltage characteristics according to the shapes of the sensing elements and the vibration transmission members of the present specification;

FIGS. 24A to 24D are views showing the sensing voltage characteristics according to a change in the thickness of the base member of the present specification;

FIGS. 25A to 25D are views showing the sensing voltage characteristics according to a change in strength of the base member of the present specification;

FIGS. 26A to 26C are views showing the sensing voltage characteristics according to a change in the material of the vibration transmission member of the present specification;

FIG. 27 is a perspective view showing a vibration sensing apparatus according to one embodiment of the present specification;

FIG. 28 is a plan view showing the vibration sensing apparatus according to one embodiment of the present specification;

FIG. 29 is a cross-sectional view taken along line III-III′ in FIG. 28; and

FIG. 30 is an exploded perspective view illustrating the vibration sensing apparatus according to one embodiment of the present specification.

### DETAILED DESCRIPTION

Advantages and features of the present specification and methods for achieving them will become clear with reference to embodiments described below in detail in conjunction with the accompanying drawings. However, the present specification is not limited to embodiments disclosed below but will be implemented in various different forms, these embodiments are merely provided to make the disclosure of the present specification complete and fully inform those skilled in the art to which the present specification pertains of the scope of the present specification.

Since shapes, sizes, ratios, angles, numbers, and the like disclosed in the drawings for describing the embodiments of the present specification are illustrative, the present specification is not limited to the illustrated items. The same reference number denotes the same components throughout the specification. In addition, in describing the present specification, when it is determined that the detailed description of a related known technology may unnecessarily obscure the gist of the present specification, detailed description thereof will be omitted. When “comprise,” “have,” “consist of,” or the like described herein are used, other parts may be added unless “only” is used. When a component is expressed in the singular, it includes a case in which the component is provided as a plurality of components unless specifically stated otherwise.

In construing a component, the component is construed as including the margin of error even when there is no separate explicit description about the margin of error.

When the positional relationship is described, for example, when the positional relationship between two parts is described using “on,” “above,” “under,” “next to,” or the like, one or more other parts may be positioned between the two parts unless “immediately” or “directly” is used.

When the temporal relationship is described, when the temporal relationship is described using “after,” “subsequently,” “then,” “before,” or the like, it may also include a non-consecutive case unless “immediately” or “directly” is used.

Although a first, a second, and the like are used to describe various components, these components are not limited by these terms. These terms are only used to distinguish one component from another component. Therefore, a first component described below may be a second component within the technical spirit of the present specification.

In the description of the components of the present specification, terms such as first, second, A, B, (a), and (b) may be used. These terms are only for the purpose of distinguishing one component from another component, and the nature, sequence, order, or the like of the corresponding component is not limited by these terms. When a certain component is described as being “connected,” “coupled,” or “joined” to another component, the certain component may be connected or joined directly to another component, but it should be understood that other components may be “interposed” between the certain component and another component, which may be connected or coupled indirectly unless otherwise stated specially.

It should be understood that “at least one” includes any combination of one or more of associated components. For example, “at least one of first, second, and third components” may include not only the first, second, or third component, but also any combination of two or more of the first, second, and third components.

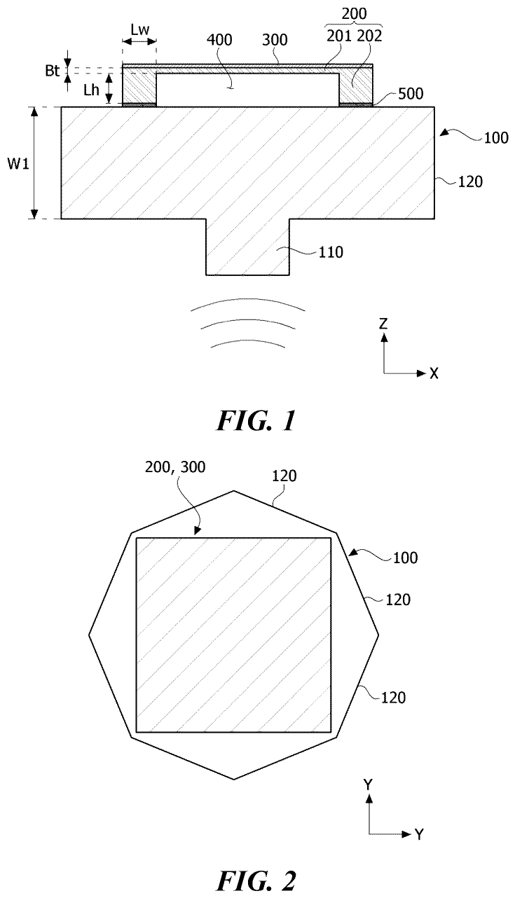

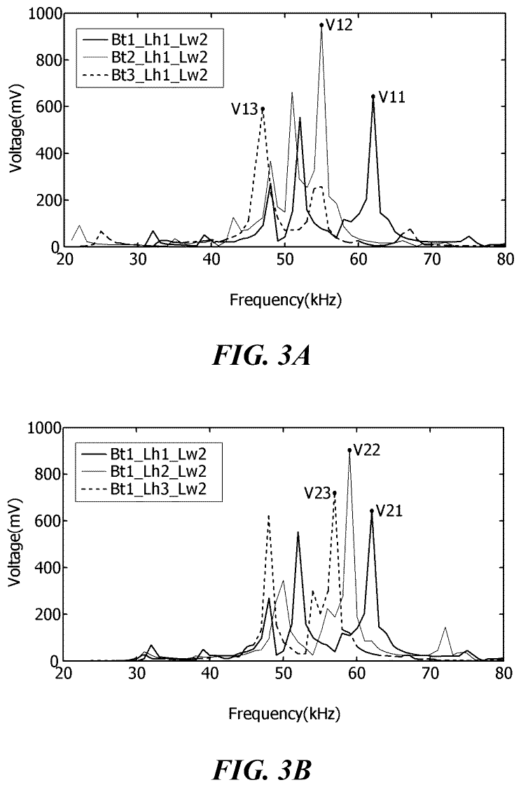

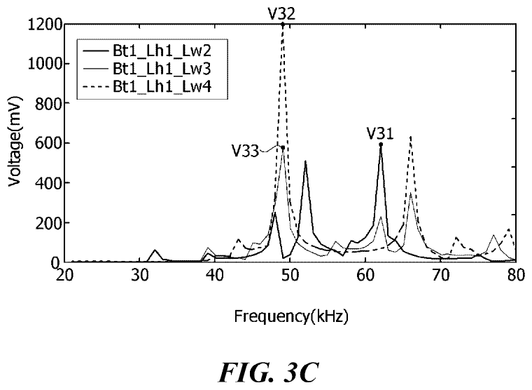

FIG. 1 is a view showing a vibration sensing apparatus according to a first embodiment of the present specification. FIG. 2 is a plan view showing the vibration sensing apparatus according to the first embodiment of the present specification. FIGS. 3A to 3C are drawings showing the sensing voltage levels according to shapes of the vibration transmission member of the present disclosure.

Referring to FIG. 1, a vibration sensing apparatus according to an embodiment may include a base member 100, a vibration transmission member 200, and a sensing element 300.

The base member 100 may include a first surface on which the vibration transmission member 200 is disposed and may have a predetermined thickness W1. The thickness W1 of the base member 100 may be thicker than the maximum thickness of the vibration transmission member 200, but the embodiments of the present specification are not limited thereto. Since the resonant frequency of the base member 100 may vary with its thickness, the thickness of the base member 100 may be determined based on a target resonant frequency.

The base member 100 may include one or more materials of stainless steel, aluminum (Al), an aluminum (Al) alloy, magnesium (Mg), a magnesium (Mg) alloy, a magnesium lithium (Mg—Li) alloy, and plastic, but the embodiments of the present specification are not limited thereto.

The base member 100 may have a polygonal shape, such as rectangular or hexagonal, an elliptical shape, and a circular shape on a plane, but the embodiments of this specification are not limited thereto. The resonant frequency may be adjusted according to the shape of the base member 100.

A fastening part 110, which is fixed to a measurement target, may be disposed on the base member 100. The fastening part 110 may be disposed at a lower portion of the base member 100, but the embodiments of the present specification are not limited thereto. For example, the fastening part 110 may be disposed on a side surface of the base member 100 or may include a separate connecting member.

The measurement target on which the vibration sensing apparatus is placed may be a variety of systems or structures that require vibration sensing. For example, the measurement target may include, but are not limited to, architectural structures, vehicles, ships, display devices, and many other objects that require vibration sensing.

The vibration transmission member 200 may amplify vibrations generated by the measurement target and transmit them to the sensing element 300. The vibration transmission member 200 may be designed to have a resonant frequency that matches the target vibration to be sensed in the measurement target.

The vibration transmission member 200 may include a first transmission portion 201 on which the sensing element 300 is disposed, and a second transmission portion 202 for spacing the first transmission portion 201 from the base member 100. The first transmission portion 201 may be a membrane, a diaphragm, or a plate, but the embodiments of the present specification are not limited thereto. The second transmission portion 202 may be a support portion or a leg portion, but the embodiments of the present specification are not limited thereto. The area of the first transmission portion 201 may be formed to be the same as or larger than that of the sensing element 300, but the embodiments of the present specification are not limited thereto. The second transmission portion 202 may be disposed at an edge of the first transmission portion 201 to form a space 400 between the first transmission portion 201 and the base member 100. The second transmission portion 202 may be disposed to surround the first transmission portion 201, but the embodiments of the present specification are not limited thereto. For example, the second transmission portion 202 may be disposed in a partial area of an edge of the first transmission portion 201.

The vibration transmission member 200 may include one or more materials of stainless steel, aluminum (Al), an aluminum (Al) alloy, magnesium (Mg), a magnesium (Mg) alloy, a magnesium lithium (Mg—Li) alloy, and plastic, but the embodiments of the present specification are not limited thereto. For example, the materials of the vibration transmission member 200 may be the same as or different from that of the base member 100.

The first transmission portion 201 of the vibration transmission member 200 may have a polygonal shape, such as rectangular or hexagonal, an elliptical shape, and a circular shape on a plane, but the embodiments of the present specification are not limited thereto.

The thickness Bt of the first transmission portion 201 in the third direction (Z-axis direction) may be less than the width Lw of the second transmission portion 202 in the first direction (X-axis direction), but the embodiments of the present specification are not limited thereto. The first transmission portion 201 and the second transmission portion 202 may be integrally formed, but the embodiments of the present specification are not limited thereto. For example, the first transmission portion 201 and the second transmission portion 202 may each be separately formed and then coupled to each other. The first transmission portion 201 and the second transmission portion 202 may be formed of different materials.

In FIG. 3A, the horizontal axis represents the frequency (kHz) and the vertical axis represents the sensing voltage (mV). Referring to FIG. 3A, the dashed line indicates the case where the first transmission portion 201 has a first thickness Bt1. The thin solid line indicates the case where the first transmission portion 201 has a second thickness Bt2. The bold solid line indicates the case where the first transmission portion 201 has a third thickness Bt3. The first transmission portion 201 was configured to have the same height and width.

The dotted line shows a measured voltage value (V11) of 646.0 mV in the 62.0 kHz frequency range, the thin solid line shows a measured voltage value (V12) of 952.0 mV in the 55.0 KHz frequency range, and the thick solid line shows a measured voltage value (V13) of 591.5 mV in the 47.0 KHz frequency range. The first thickness Bt1 may be thicker than the second thickness Bt2, and the second thickness Bt2 may be thicker than the third thickness Bt3. Accordingly, it can be seen that the resonant frequency increases relatively as the thickness of the first transmission portion 201 increases.

Referring to FIG. 3B, the thick solid line indicates the case where the second transmission portion 202 has a first height Lh1. The thin solid line indicates the case where the second transmission portion 202 has a second height Lh2. The dashed line indicates the case where the second transmission portion 202 has a third height Lh3. The first transmission portion 201 was configured to have the same thickness and width.

The thick solid line shows a measured voltage value (V21) of 646.0 mV in the 62.0 KHz frequency range, the thin solid line shows a measured voltage value (V22) of 907.7 mV in the 59.0 kHz frequency range, and the dotted line shows a measured voltage value (V23) of 722.6 mV in the 57.0 KHz frequency range. The first height Lh1 may be higher than the second height Lh2, and the second height Lh2 may be higher than the third height Lh3. Accordingly, it can be seen that the resonant frequency increases relatively as the height of the second transmission portion 202 increases.

Referring to FIG. 3C, the thick solid line shows the case where the second transmission portion 202 has a first width Lw2. The thin solid line shows the case where the second transmission portion 202 has a second width Lw3. The dashed line shows the case where the second transmission portion 202 has a third width Lw4. The first transmission portion 201 were configured to have the same thickness and height.

The thick solid line shows a measured voltage value (V31) of 646.0 mV in the 62.0 kHz frequency range, the thin solid line shows a measured voltage value (V32) of 627.6 mV in the 49.0 kHz frequency range, and the dotted line shows a measured voltage value (V33) of 1322.0 mV in the 49.0 kHz frequency range. The first width Lw2 may be wider than the second width Lw3, and the second width Lw3 may be wider than the third width Lw4. Accordingly, it can be seen that the resonant frequency increases relatively as the width of the second transmission portion 202 increases.

A main resonant frequency may be increased by increasing one or more of the thickness Bt of the first transmission portion, the height Lh of the second transmission portion, and the width Lw of the second transmission portion. Conversely, the main resonant frequency may be decreased by decreasing one or more of the thickness Bt of the first transmission portion, the height Lh of the second transmission portion, and the width Lw of the second transmission portion.

The vibration transmission member 200 and the base member 100 may be coupled by a coupling member 500. The coupling member 500 may be configured to maximize the vibration of the vibration transmission member 200 to be amplified and transmitted to the sensing element 300. The coupling member 500 may include a material that minimizes vibration absorption (or shock absorption).

For example, the coupling member 500 may include one or more materials of a thermosetting adhesive, a photocurable adhesive, a heat stacking adhesive, a double-sided tape, a double-sided foam tape, a double-sided foam pad, and a double-sided cushion tape, but the embodiments of the present specification are not limited thereto.

The resonant frequency of the vibration transmission member 200 may be adjusted according to the target vibration frequency that needs to be sensed from the measurement target. The resonant frequency of the vibration transmission member 200 may be adjusted by changing the size of the vibration transmission member, the area of the first transmission portion, and the material of the vibration transmission member. Since the vibration generated by the measurement target coincides with the resonance frequency of the vibration transmission member, the vibration may be amplified.

The sensing element 300 may be disposed on the vibration transmission member 200 to receive an amplified vibration signal. The sensing element 300 may include a piezoelectric material (or an electroactive material) having the piezoelectric effect. For example, the piezoelectric material may be characterized in that a potential difference is generated due to dielectric polarization caused by a change in the relative positions between positive (+) and negative (−) ions as a result of compression or torsion acting on the crystal structure by an external force, and conversely, vibration is generated by an electric field due to an applied voltage. For example, the sensing element 300 may be expressed by different terms such as a piezoelectric layer, a piezoelectric material layer, an electroactive layer, a piezoelectric material part, an electroactive part, a piezoelectric structure, a piezoelectric composite layer, a piezoelectric composite, or a piezoelectric ceramic composite, but the embodiments of the present specification are not limited thereto.

The piezoelectric element may consist of an inorganic material part or a piezoelectric material part. The inorganic material portion may include a piezoelectric material, a composite piezoelectric material, or an electroactive material having a piezoelectric effect. The piezoelectric element may be made of a ceramic-based piezoelectric materials that may realize relatively high vibrations, or piezoelectric ceramics with a perovskite-based crystal structure.

According to one embodiment of the present specification, the vibrations generated by the measurement target may be amplified by the base member 100 and/or the vibration transmission member 200 and applied to the sensing element 300. As a result, the sensing element 300 may experience a large potential difference as the amplified vibrations cause significant compression or torsion phenomena in its crystal structure. Therefore, vibration sensitivity may be increased by generating a high-level voltage value.

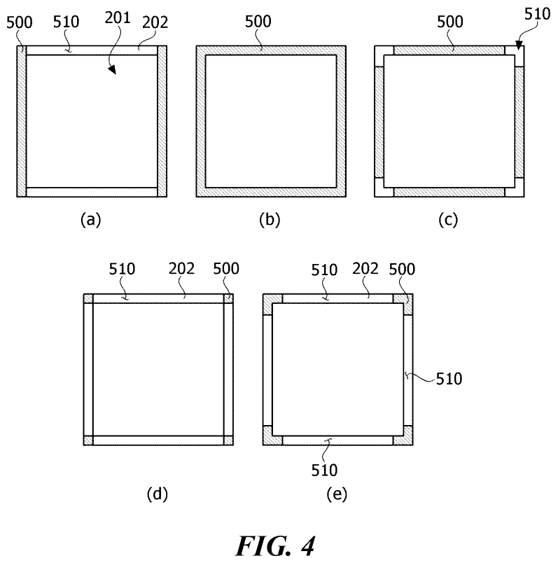

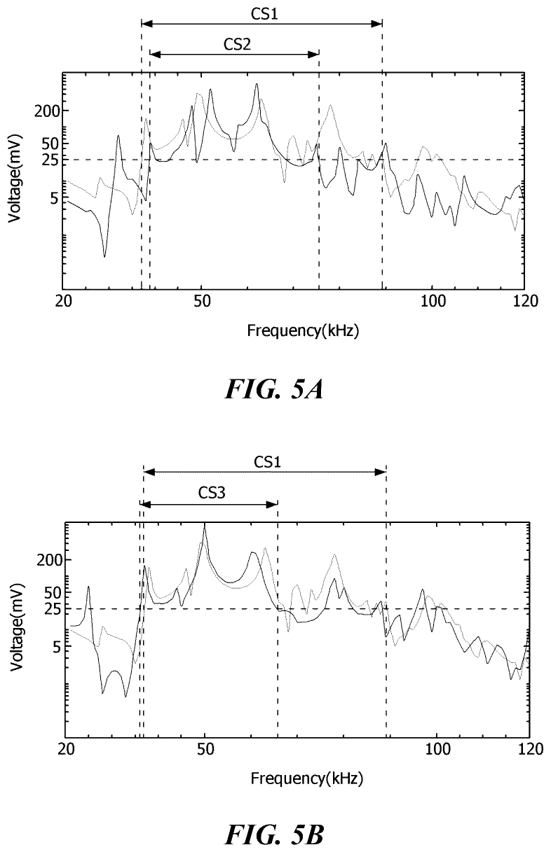

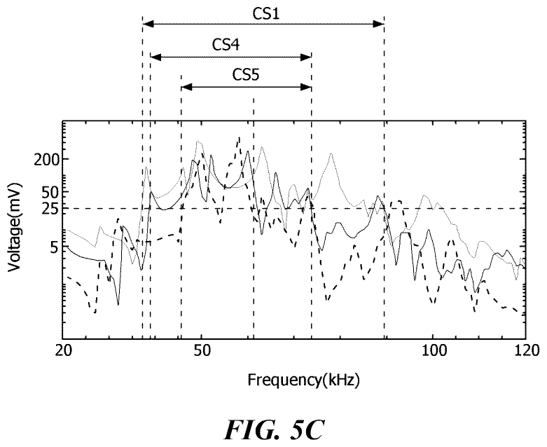

FIG. 4 is a diagram showing various shapes of the coupling member according to an embodiment of the present specification. FIGS. 5A to 5C are diagrams showing sensing ranges according to the shapes of the coupling members.

As shown in (a) of FIG. 4, the coupling member 500 may be disposed on the opposite sides of the second transmission portion 202. As shown in (b) of FIG. 4, the coupling member 500 may be disposed entirely on all four sides of the second transmission portion 202. As shown in (c) of FIG. 4, the coupling member 500 may be disposed on all but the corner portions of the second transmission portion 202 to form a plurality of openings 510 that expose the corner portions of the second transmission portion 202. As shown in (d) of FIG. 4, the coupling member 500 may also be disposed at the corners of the second transmission portion 202. As shown in (e) of FIG. 4, the coupling member 500 may be disposed on the peripheral portions including the corners of the second transmission portion 202.

Referring to FIG. 5A, the thin solid line shows the frequency characteristic of (a) in FIG. 4, and the thick solid line shows the frequency characteristic of (b) in FIG. 4. The detectable frequency band CS1 when the coupling member 500 is disposed entirely on all four sides of the second transmission portion 202, as shown by the thick solid line, may be wider than the detectable frequency band CS2 when the coupling member 500 is disposed on only two sides of the second transmission portion 202, as shown by the thin solid line. The detectable frequency region may be a region where a voltage value is greater than or equal to a reference value (e.g., 25 mV), but the embodiments of the present disclosure are not limited thereto.

Referring to FIG. 5B, the thick solid line shows the frequency characteristic of (b) in FIG. 4, and the thin solid line shows the frequency characteristic of (c) in FIG. 4. It can be confirmed that when the coupling member 500 is disposed entirely on all four sides of the second transmission portion 202, as shown by the thick solid line, the detectable frequency band is become wider than when the coupling member 500 is not disposed on the corners of the second transmission portion 202, as shown by the thin solid line. It can be seen that the frequency band CS1 when the coupling member 500 is disposed entirely on all four sides of the second transmission portion 202 is become wider compared to the frequency band CS3 when the coupling member 500 is not disposed on the corners of the second transmission portion 202.

Referring to FIG. 5C, the thick solid line shows the frequency characteristic of (b) in FIG. 4, the thin solid line shows the frequency characteristic of (e) in FIG. 4, and the dotted line shows the frequency characteristic of (d) in FIG. 4. It can be confirmed that when the coupling member 500 is disposed entirely on all four sides of the second transmission portion 202, as shown by the bold solid line, the detectable frequency band is become wider compared to when the coupling member 500 is disposed on the peripheral portions including the corners of the second transmission portion 202, as shown by the thin solid line, and when the coupling member 500 is disposed only on the corners of the second transmission portion 202, as shown by the dotted line.

It can be seen that the frequency band CS1 when the coupling member 500 is disposed entirely on all four sides of the second transmission portion 202 is become wider compared to the frequency band CS4 when the coupling member 500 is disposed on the peripheral portions including the corners of the second transmission portion 202 and the frequency band CS5 when the coupling member 500 is disposed on the corners of the second transmission portion 202. It can be confirmed that when the coupling member 500 is disposed on all four sides of the second transmission portion 202, as shown by the bold solid line, the detectable frequency band is become wider compared to when the coupling member 500 is disposed on the peripheral portions including the corners of the second transmission portion 202, as shown by the thin solid line, and when the coupling member 500 is disposed only on the corners of the second transmission portion 202, as shown by the dotted line.

According to the present specification, it will be appreciated that the wider detectable frequency band may be set by disposing the coupling member 500 entirely on the lower surface of the second transmission portion 202.

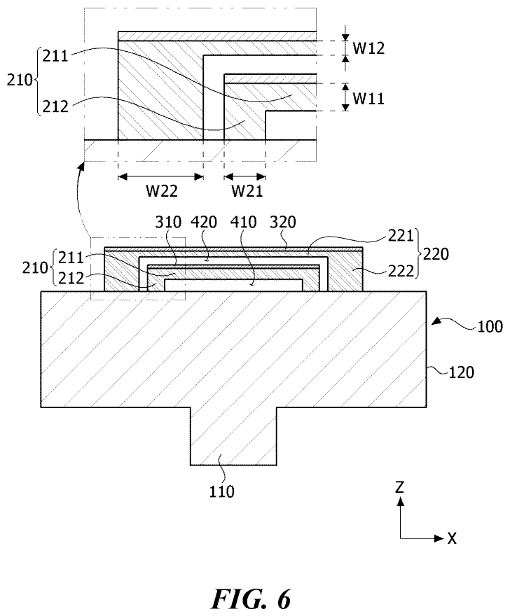

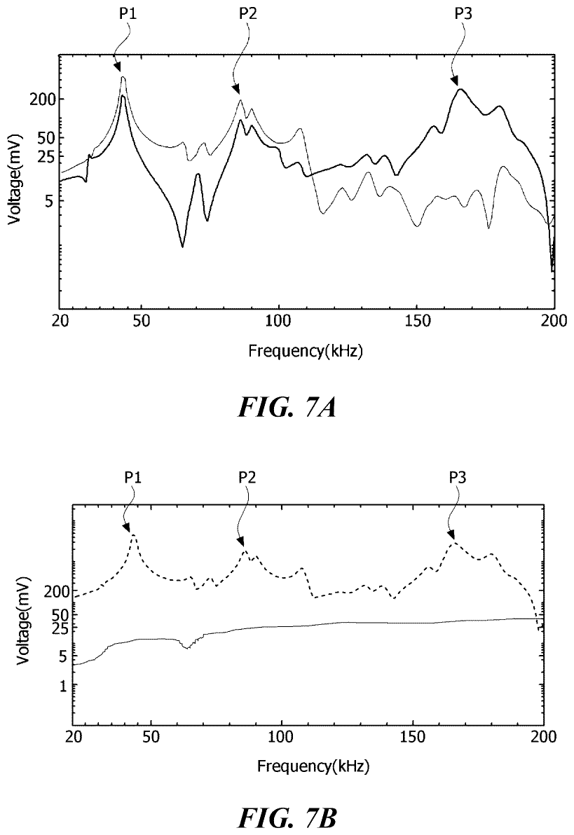

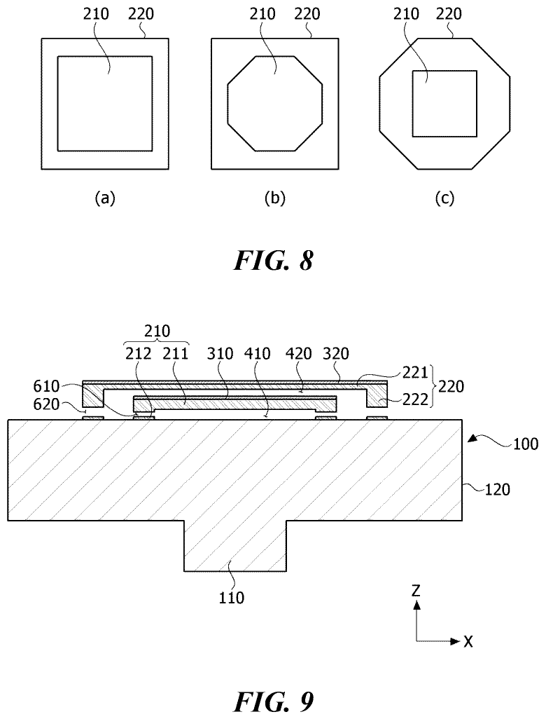

FIG. 6 is a diagram showing a vibration sensing apparatus according to a second embodiment of the present specification. FIG. 7A is a diagram showing sensing voltage levels of a plurality of sensing elements according to the embodiment of the present specification. FIG. 7B is a diagram showing sensing voltage levels of a vibration sensing apparatus according to embodiments of the present specification. FIG. 8 is a diagram showing various modified examples of the first vibration transmission member and the second vibration transmission member according to the embodiment of the present specification.

Referring to FIG. 6, the base member 100 may include a first surface on which the vibration transmission member 200 is disposed and may have a predetermined thickness W1. Since the resonant frequency of the base member 100 may vary with the thickness of the base member 100, the thickness of the base member 100 may be determined based on a desired resonant frequency. The first surface of the base member 100 may have a polygonal shape, such as rectangular or hexagonal, an elliptical shape, and a circular shape on a plane, but the embodiments of this specification are not limited thereto.

The vibration transmission member 200 may include a first vibration transmission member 210 disposed on the base member 100, and a second vibration transmission member 220 disposed on the first vibration transmission member 210. While the embodiment of the present specification illustrate two vibration transmission members 210 and 220 arranged, the embodiments of the present specification are not limited thereto. For example, the plurality of vibration transmission members may be three, or five.

While the illustrated embodiment shows a single first vibration transmission member 210 disposed below the second vibration transmission member 220, the embodiments of the present specification are not limited thereto. A plurality of first vibration transmission members 210 may be disposed below the second vibration transmission member 220.

The first vibration transmission member 210 may include a first-first transmission portion 211 on which a first sensing element 310 is disposed and a first-second transmission portion 212 for spacing the first-first transmission portion 211 and the base member 100 from each other. The first-second transmission portion 212 may be disposed at an edge of the first-first transmission portion 211 to form a first space 410 between the first-first transmission portion 211 and the base member 100.

The second vibration transmission member 220 may include a second-first transmission portion 221 on which a second sensing element 320 is disposed, and a second-second transmission portion 222 for spacing the second-first transmission portion 221 and the base member 100. The second-second transmission portion 222 may be disposed at an edge of the second-first transmission portion 221 to form a second space 420 between the second-first transmission portion 221 and the base member 100. The first vibration transmission member 210 and the first sensing element 310 may be disposed within the second space 420.

The area of the second-first transmission portion 221 may be larger than the area of the first-first transmission portion 211, but the embodiments of the present specification are not limited thereto. The thickness W12 of the second-first transmission portion 221 may be the same as or different from the thickness W11 of the first-first transmission portion 211. The width W22 of the second-second transmission portion 222 may be the same as or different from the width W21 of the first-second transmission portion 212.

As illustrated in FIGS. 3A to 3C, the main resonant frequency may increase as one or more of the thickness Bt of the first transmission portion, the height Lh of the second transmission portion, and the width Lw of the second transmission portion increases. In order to adjust the frequency, the thickness W12 of the second-first transmission portion 221 may be thicker than the thickness W11 of the first-first transmission portion 211. Alternatively, the height of the second-second transmission portion 222 may be higher than the height of the first-second transmission portion 212. Alternatively, the width W22 of the second-second transmission portion 222 may be wider than the width W21 of the first-second transmission portion 212.

The resonant frequencies of the first vibration transmission member 210 and the second vibration transmission member 220 may be adjusted according to the target resonant frequency of the measurement target. The resonant frequencies of the first vibration transmission member 210 and the second vibration transmission member 220 may be designed to be different. For example, the first vibration transmission member 210 may be designed to have a resonant frequency matched to the low frequency region and the second vibration transmission member 220 may be designed to have a resonant frequency matched to the high frequency region, but the embodiments of the present specification are not limited thereto. The low frequency may be 400 Hz or less, or 500 Hz or less, but the embodiments of the present specification are not limited thereto. The high frequency may be 1 kHz or more, 2 kHz or more, or 3 kHz or more, but the embodiments of the present specification are not limited thereto. The first vibration transmission member 210 and the second vibration transmission member 220 may have a plurality of resonant frequencies. Among the plurality of resonant frequencies, the peak with the largest amplitude may be referred to as a main resonant frequency, and the remaining peaks may be referred to as sub-resonant frequencies.

Referring to FIG. 7A, the thin solid line shows the frequency characteristic of the second sensing element 320, and the thick solid line shows the frequency characteristic of the first sensing element 310. Vibration in the frequency region of 50 kHz or less may result in a higher sensing voltage of the second sensing element 320 (P1). Vibration in the frequency region 150 kHz or more may result in higher sensing voltages of the first sensing element 310 (P3). Therefore, the sensing value of the first sensing element 310 or the second sensing element 320 may be selected depending on the frequency regions to ensure a high sensing sensitivity in a wide frequency region. According to the embodiment, by adjusting the resonant frequency region of the vibration transmission members 200, a wide sensing range from a low frequency region to a high frequency region may be achieved, which may ensure that a high sensing sensitivity may be obtained in the particular frequency regions P1, P2, and P3.

Referring to FIG. 7B, the sensing value of the vibration sensing apparatus according to the embodiment, represented by the dotted line, may be higher than that of a conventional ultrasonic sensor (AE sensor), shown by the solid line, across all frequency regions. For example, it can be seen that in the particular frequency regions P1, P2, and P3, a significant improvement in sensing sensitivity may be achieved in comparison with conventional ultrasonic sensors. For example, the resonant frequencies of the vibration transmission members may be adjusted to have peaks in the 45 kHz frequency region (P1), the 80 KHz frequency region (P2), and the 170 kHz frequency region (P3). However, the embodiments of the present specification are not limited thereto. For example, if the target vibration frequencies to be detected from the measurement target are 120 kHz, 380 kHz, and 550 kHz, the resonant frequencies may be adjusted by changing the area, number, or material of the base member and the vibration transmission member to match the corresponding vibration frequencies.

Referring to FIG. 8, the first vibration transmission member 210 and the second vibration transmission member 220 may have the same shape as each other or may be different from each other. For example, referring to (a) of FIG. 8, both the first vibration transmission member 210 and the second vibration transmission member 220 may have a rectangular shape. For example, referring to (b) of FIG. 8, the first vibration transmission member 210 may have a hexagonal shape and the second vibration transmission member 220 may have a square shape. For example, referring to (c) of FIG. 8, the first vibration transmission member 210 may have a rectangular shape and the second vibration transmission member 220 may have a hexagonal shape. The shapes of the first vibration transmission member 210 and the second vibration transmission member 220 are not limited thereto.

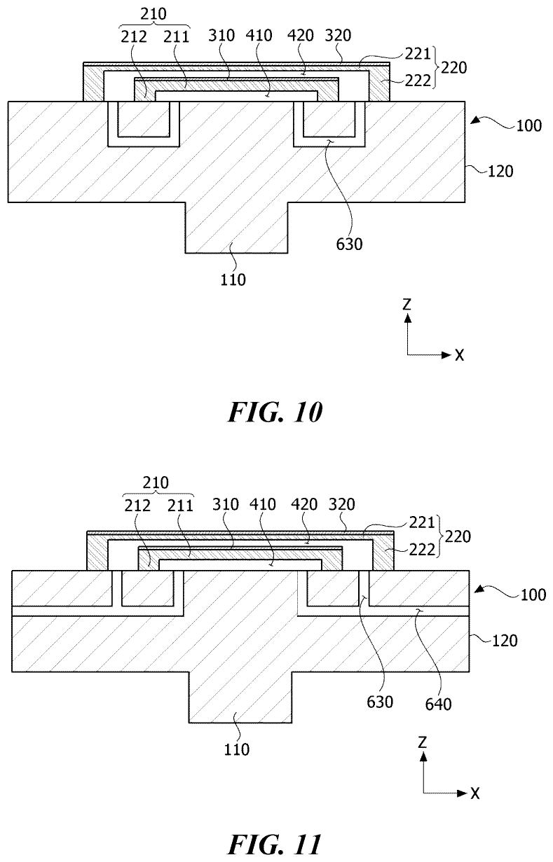

FIG. 9 is a diagram showing vent holes formed in the vibration sensing apparatus according to the second embodiment of the present specification. FIG. 10 is a first modified example of FIG. 9. FIG. 11 is a second modified example of FIG. 9.

Referring to FIG. 9, vent holes 610 and 620 may be formed in the first and second vibration transmission members 210 and 220. The vent holes 610 and 620 serves to regulate the internal pressure of spaces 410 and 420 to improve amplification performance. The first vibration transmission member 210 may have a first vent hole 610 formed on a side surface of the first-second transmission portion 212, but the embodiments of the present specification are not limited thereto. The first vent hole 610 may be positioned to overlap one side of the first-two transmission portion 212. The first vent hole 610 may be connected to the first space 410. The second transmission portion 202 may have a second vent hole 620 formed on a side surface of the second-second transmission portion 222, but the embodiments of the present specification are not limited thereto. The second vent hole 620 may be formed to overlap one side of the second-second transmission portion 222. The second vent hole 620 may be connected to the second space 420. The first vent hole 610 and the second vent hole 620 may be formed in positions facing each other, but the embodiments of the present specification are not limited thereto. For example, the first vent hole 610 and the second vent hole 620 may be positioned in a staggered configuration. The first vent hole 610 and the second vent hole 620 may be spaced apart from each other.

Referring to FIG. 10, the first space 410 of the first vibration transmission member 210 and the second space 420 of the second vibration transmission member 220 may be connected by a third vent hole 630. Thus, the first space 410 of the first vibration transmission member 210 and the second space 420 of the second vibration transmission member 220 may be connected to form an internal circulation path. Therefore, internal airflow control may be achieved.

The third vent hole 630 may be formed within the base member 100, but the embodiments of the present specification are not limited thereto. For example, the first space 410 and the second space 420 may be connected by forming a vent hole on a side surface of the first vibration transmission member 210.

Referring to FIG. 11, the first space 410 of the first vibration transmission member 210 and the second space 420 of the second vibration transmission member 220 may be connected by a third vent hole 630, and the third vent hole 630 may be connected to the outside via a fourth vent hole 640. The third vent hole 630 and the fourth vent hole 640 may be formed within the base member 100. The third vent hole 630 may include one side connected to the first space 410 and the other side connected to the second space 420. The fourth vent hole 640 may include one side connected to the third vent hole 630 and the other side exposed to the side surface 120 of the base member 100. Therefore, the internal pressure of the spaces 410 and 420 may be adjusted by the inflow of external air.

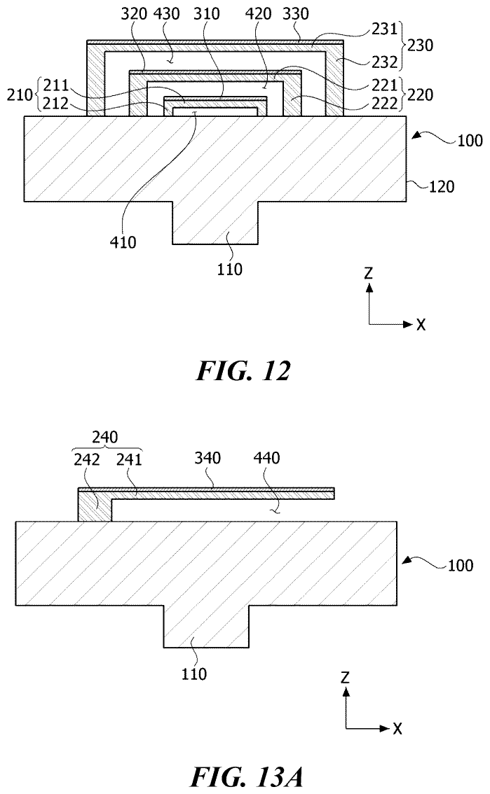

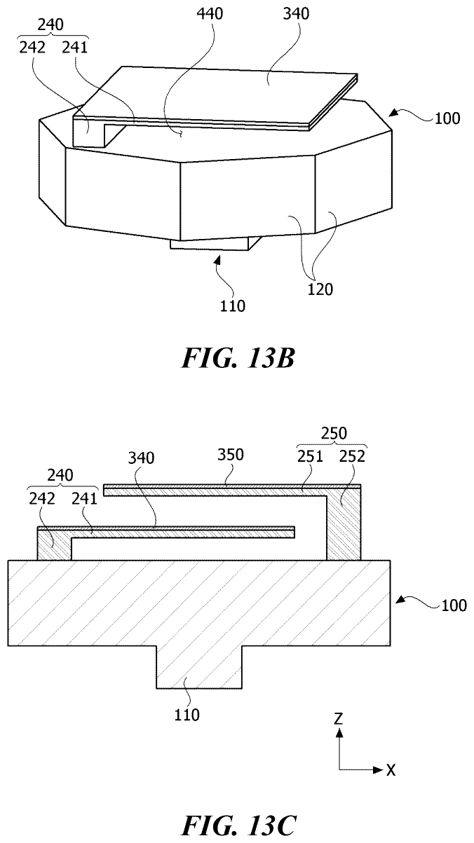

FIG. 12 is a diagram showing a vibration sensing apparatus according to a third embodiment of the present specification. FIGS. 13A and 13B are diagrams showing a vibration sensing apparatus according to a fourth embodiment of the present specification. FIG. 13C is a modified example of FIG. 13A.

Referring to FIG. 12, the first vibration transmission member 210 may include a first-first transmission portion 211 on which the first sensing element 310 is disposed, and a first-second transmission portion 212 for spacing the first-first transmission portion 211 and the base member 100. The first-second transmission portion 212 may be disposed at an edge of the first-first transmission portion 211 to form a first space 410 between the first-first transmission portion 211 and the base member 100.

The second vibration transmission member 220 may include a second-first transmission portion 221 on which the second sensing element 320 is disposed and a second-second transmission portion 222 for spacing the second-first transmission portion 221 and the base member 100. The second-second transmission portion 222 may be disposed at an edge of the second-first transmission portion 221 to form a second space 420 between the second-first transmission portion 221 and the base member 100. The first vibration transmission member 210 and the first sensing element 310 may be disposed within the second space 420.

The third vibration transmission member 230 may include a third-first transmission portion 231 on which the third sensing element 330 is disposed and a third-second transmission portion 232 for spacing the third-first transmission portion 231 and the base member 100. The third-second transmission portion 232 may be disposed at an edge of the third-first transmission portion 231 to form a third space 430 between the third-first transmission portion 231 and the base member 100. The first vibration transmission member 210 and the second vibration transmission member 220 may be disposed within the third space 430.

According to the present specification, a plurality of vibration transmission members 210, 220, and 230 may be arranged in a stacked manner to amplify vibrations in a target vibration frequency region, thereby forming a wide band vibration sensing apparatus 300. However, the embodiments of the present specification are not limited thereto. For example, at least some of the plurality of vibration transmission members 210, 220, and 230 may not be arranged.

Referring to FIGS. 13A and 13B, a fourth vibration transmission member 240 may include a fourth-first transmission portion 241 on which a fourth sensing element 340 is disposed and a fourth-second transmission portion 242 for spacing the fourth-first transmission portion 241 and the base member 100. The fourth-second transmission portion 242 may be disposed on one side of the fourth-first transmission portion 241. A fourth space 440 formed between the fourth-first transmission portion 241 and the base member 100 may be open. According to the embodiment, the fourth vibration transmission member 240 may have a shape of a cantilever having one side fixed to the base member 100. The shapes of the base member 100 and the fourth vibration transmission member 240 may be the same or different. For example, the base member 100 may have a hexagonal shape, and the fourth vibration transmission member 240 and the fourth sensing element 340 may have a square shape, but the embodiments of the present specification are not limited thereto.

Referring to FIG. 13C, a fifth vibration transmission member 250 may further be disposed above of the fourth vibration transmission member 240. The resonant frequencies of the fourth vibration transmission member 240 and the fifth vibration transmission member 250 may be adjusted according to the target resonant frequency of the measurement target. The resonant frequencies of the fourth vibration transmission member 240 and the fifth vibration transmission member 250 may be configured differently. For example, the fourth vibration transmission member 240 may be configured to have a resonant frequency matched to the low frequency region, and the fifth vibration transmission member 250 may be configured to have a resonant frequency matched to the high frequency region. The fourth vibration transmission member 240 and the fifth vibration transmission member 250 according to the embodiment may each have a shape of a cantilever having one side fixed to the base member 100. The fifth vibration transmission member 250 may be positioned higher than the fourth vibration transmission member 240.

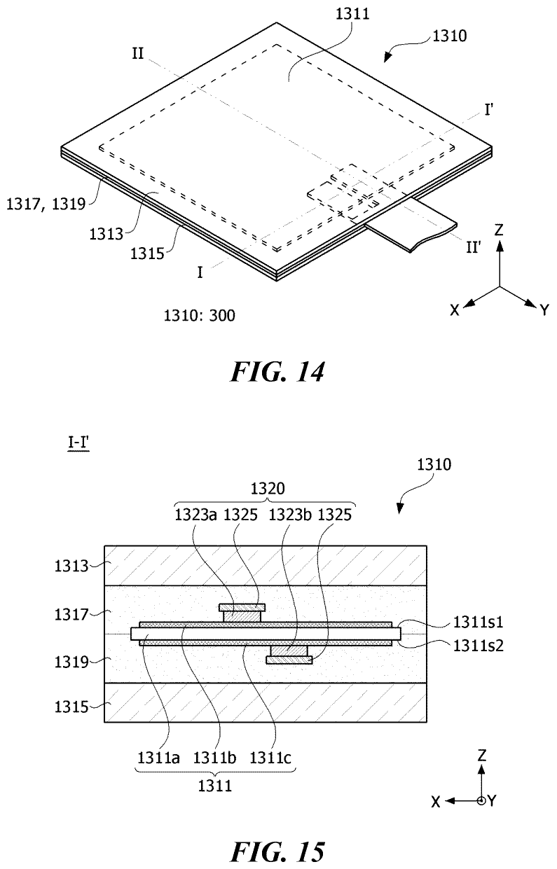

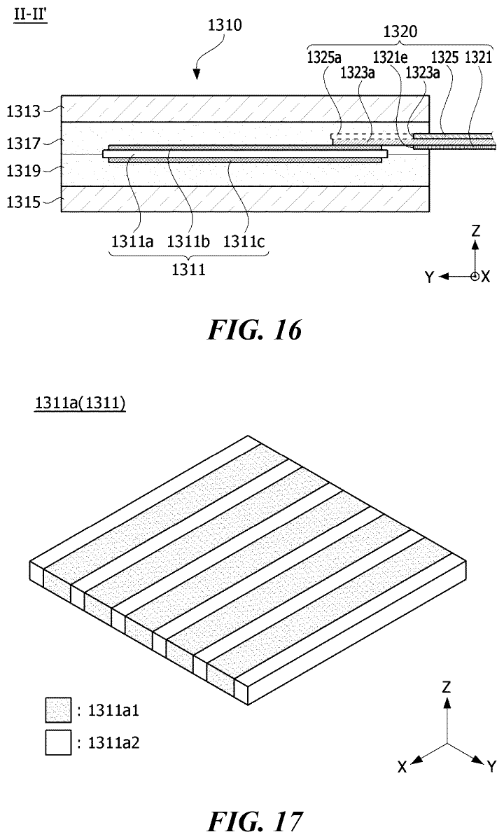

FIG. 14 is a diagram showing a vibration sensing apparatus according to one embodiment of the present specification. FIG. 15 is a cross-sectional view taken along line I-I′ in FIG. 14 according to the embodiment of the present specification. FIG. 16 is a cross-sectional view taken along line II-II′ in FIG. 14 according to the embodiment of the present specification.

Referring to FIGS. 14 to 16, a vibration sensing apparatus according to one embodiment of the present specification may include at least one vibration sensing member 1310. The vibration sensing member 1310 may be made of a ceramic-based piezoelectric material that may implement relatively strong vibrations or a piezoelectric ceramic having a perovskite-based crystal structure. For example, the vibration sensing member 1310 may be a vibration generating element, a vibration film, a vibration generating film, a vibrator, an active vibrator, an active vibration receiver, an actuator, an exciter, a film actuator, a film exciter, an ultrasonic actuator, or an active vibration member, but the embodiments of the present specification are not limited thereto. The sensing element 300 may be configured as the vibration sensing member 1310. The vibration sensing member and the sensing element may be used interchangeably.

The vibration sensing apparatus may include a vibration sensing part 1311.

For example, the vibration sensing part 1311 may include a piezoelectric vibration part. The vibration sensing part 1311 may include at least one of a piezoelectric inorganic material and a piezoelectric organic material. For example, the vibration sensing part 1311 may include a vibration element, a piezoelectric element, a piezoelectric element part, a piezoelectric element layer, a piezoelectric structure, a piezoelectric vibration part, or a piezoelectric vibrating layer, but the embodiments of the present specification are not limited thereto.

The vibration sensing part 1311 according to one embodiment of the present specification may include a sensing portion 1311a, a first electrode portion 1311b, and a second electrode portion 1311c.

The sensing portion 1311a may include a piezoelectric material or an electroactive material having the piezoelectric effect. For example, the sensing portion 1311a may be a piezoelectric layer, a piezoelectric material layer, an electroactive layer, a piezoelectric composite layer, a piezoelectric composite, or a piezoelectric ceramic composite, but the embodiments of the present specification are not limited thereto.

The sensing portion 1311a may be formed of a ceramic-based piezoelectric ceramic that may implement relatively strong vibrations or formed of a piezoelectric ceramic that has a perovskite-based crystal structure. For example, the sensing portion 1311a may include at least one of PbTiO₃, PbZrO₃, PbZrTiO₃, BaTiO₃, and SrTiO₃, but the embodiments of the present specification are not limited thereto.

The piezoelectric ceramic may be formed as a single crystal ceramic having a single crystal structure or formed of a ceramic material having a polycrystalline structure or a polycrystalline ceramic. The piezoelectric material of the single crystal ceramic may include a-AlPO₄, α-SiO₂, LiNbO₃, Tb₂ (MoO₄)₃, Li₂B₄O₇, or ZnO, but the embodiments of the present specification are not limited thereto. The piezoelectric material of the polycrystalline ceramic may include a lead zirconate titanate (PZT)-based material including lead (Pb), zirconium (Zr), and titanium (Ti), or a lead zirconate nickel niobate (PZNN)-based material including lead (Pb), zirconium (Zr), nickel (Ni), and niobium (Nb), but the embodiments of the present specification are not limited thereto. For example, the sensing portion 1311a may include at least one of CaTiO₃, BaTiO₃, and SrTiO₃ that do not include lead (Pb), but the embodiments of the present specification are not limited thereto.

The first electrode portion 1311b may be disposed on a first surface (or an upper surface or front surface) 1311s1 of the sensing portion 1311a. The first electrode portion 1311b may have the same size as the sensing portion 1311a or have a smaller size than the sensing portion 1311a, but the embodiments of the present specification are not limited thereto.

The second electrode portion 1311c may be disposed on a second surface (or a lower surface or back surface) 1311s2 that differs from or is opposite to the first surface 1311s1 of the sensing portion 1311a. The second electrode portion 1311c may have the same size as the sensing portion 1311a or may have a smaller size than the sensing portion 1311a, but the embodiments of the present disclosure are not limited thereto. For example, the second electrode portion 1311c may have the same shape as the sensing portion 1311a, but the embodiments of the present specification are not limited thereto.

One or more of the first electrode portion 1311b and the second electrode portion 1311c according to one embodiment of the present specification may be made of a transparent conductive material, a semitransparent conductive material, or an opaque conductive material. For example, the transparent or semitransparent conductive material may include indium tin oxide (ITO) or indium zinc oxide (IZO), but the embodiments of the present specification are not limited thereto. The opaque conductive material may include gold (Au), silver (Ag), platinum (Pt), palladium (Pd), molybdenum (Mo), magnesium (Mg), carbon, or silver (Ag) containing glass frit, or may be made of an alloy thereof, but the embodiments of the present specification are not limited thereto. For example, each of the first electrode portion 1311b and the second electrode portion 1311c may include silver (Ag) having low resistivity to improve the electrical characteristics and/or vibration characteristics of the sensing portion 1311a. For example, carbon may be a carbon material including carbon black, ketjen black, carbon nanotubes, and graphite, but the embodiments of the present specification are not limited thereto.

The vibration sensing member 1310 according to one embodiment of the present specification may further include a first cover member 1313 and a second cover member 1315.

The first cover member 1313 may be disposed on the first surface of the vibration sensing part 1311. For example, the first cover member 1313 may be formed to cover the first electrode portion 1311b of the vibration sensing part 1311. For example, the first cover member 1313 may be formed to have a larger size than the vibration sensing part 1311, but the embodiments of the present specification are not limited thereto. The first cover member 1313 may be formed to protect the first surface and the first electrode portion 1311b of the vibration sensing part 1311.

The second cover member 1315 may be disposed on the second surface of the vibration sensing part 1311. For example, the second cover member 1315 may be formed to cover the second electrode portion 1311c of the vibration sensing part 1311. For example, the second cover member 1315 may be formed to have a larger size than the vibration sensing part 1311 and formed to have the same size as the first cover member 1313, but the embodiments of the present specification are not limited thereto. The second cover member 1315 may be formed to protect the second surface and the second electrode portion 1311c of the vibration sensing part 1311.

The first cover member 1313 and the second cover member 1315 according to one embodiment of the present specification may include the same material or different materials. For example, each of the first cover member 1313 and the second cover member 1315 may be a polyimide film, a polyethylene terephthalate film, a polyethylene naphthalate film, or the like, but the embodiments of the present specification are not limited thereto.

The first cover member 1313 may be connected or coupled to the first surface or the first electrode portion 1311b of the vibration sensing part 1311 via a first adhesive layer 1317. For example, the first cover member 1313 may be connected or coupled to the first surface or the first electrode portion 1311b of the vibration sensing part 1311 by a film laminating process using the first adhesive layer 1317 as a medium.

The second cover member 1315 may be connected or coupled to the second surface or the second electrode portion 1311c of the vibration sensing part 1311 via a second adhesive layer 1319. For example, the second cover member 1315 may be connected or coupled to the second surface or the second electrode portion 1311c of the vibration sensing part 1311 by a film laminating process using the second adhesive layer 1319 as a medium.

Each of the first adhesive layer 1317 and the second adhesive layer 1319 according to the embodiment of the present specification may include an electrically insulating material that is compressible and restorable while having adhesiveness. For example, each of the first adhesive layer 1317 and the second adhesive layer 1319 may include an epoxy resin, an acrylic resin, a silicone resin, a urethane resin, an acrylic polymer, a silicone polymer, or a urethane polymer, but the embodiments of the present specification are not limited thereto.

The first adhesive layer 1317 and the second adhesive layer 1319 may be formed between the first cover member 1313 and the second cover member 1315 to surround the vibration sensing part 1311. For example, one or more of the first adhesive layer 1317 and the second adhesive layer 1319 may be formed to partially or fully surround the vibration sensing part 1311.

One of the first cover member 1313 and the second cover member 1315 may be connected or coupled to the vibration member via the adhesive member.

One of the first cover member 1313 and the second cover member 1315 may be omitted. For example, one of the first cover member 1313 and the second cover member 1315 may be formed to cover or protect at least one of the first surface and the second surface of the vibration sensing member 1310.

The vibration sensing member 1310 according to one embodiment of the present specification may further include a signal connection member 1320.

The signal connection member 1320 may be configured to sense a change in current according to the vibration of the vibration sensing part 1311. The signal connection member 1320 may be formed to be electrically connected to the vibration sensing part 1311. The signal connection member 1320 may be formed to be electrically connected to the first electrode portion 1311b and the second electrode portion 1131c of the vibration sensing part 1311.

A portion of the signal connection member 1320 may be accommodated (or inserted) between the first cover member 1313 and the second cover member 1315. An end portion (or an end or one side) of the signal connection member 1320 may be disposed or inserted (or accommodated) in a portion between one edge portion of the first cover member 1313 and one edge portion of the second cover member 1315. The one edge portion of the first cover member 1313 and the one edge portion of the second cover member 1315 may accommodate or vertically cover the end portion (or an end or one side) of the signal connection member 1320. As a result, the signal connection member 1320 may be integrated with the vibration sensing part 1311. Accordingly, the vibration sensing member 1310 or the vibration sensing part 1311 may be implemented in the form of a film integrated with the signal connection member 1320. For example, the signal connection member 1320 may be formed as a single component with the vibration sensing part 1311, thereby achieving the uni-materialization effect. For example, the signal connection member 1320 may be formed as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but the embodiments of the present specification are not limited thereto.

The signal connection member 1320 according to one embodiment of the present specification may include a protection member 1321 and a plurality of signal lines 1323a and 1323b. For example, the signal connection member 1320 may include the protection member 1321, a first signal line 1323a, and a second signal line 1323b.

The protection member 1321 may include a transparent or opaque plastic material, but the embodiments of the present specification are not limited thereto. The protection member 1321 may have a constant width in the first direction (X) and extend in the second direction (Y) intersecting the first direction (X).

The first signal line 1323a and the second signal line 1323b may be disposed on the first surface of the protection member 1321 to be parallel to the second direction (Y) and may be spaced apart from each other or electrically separated in the first direction (X). The first signal line 1323a and the second signal line 1323b may be disposed parallel to each other on the first surface of the protection member 1321. For example, the first signal line 1323a and the second signal line 1323b may be implemented in a line shape by patterning a metal layer (or a conductive layer) formed or deposited on the first surface of the protection member 1321, but the embodiments of the present specification are not limited thereto.

The end portions (or the ends or one sides) of the first signal line 1323a and the second signal line 1323b may be separated and individually curved or bent.

The end portion (or the end or one side) of the first signal line 1323a may be electrically connected to the first electrode portion 1311b of the vibration sensing part 1311. For example, the end portion of the first signal line 1323a may be electrically connected to at least a portion of the first electrode portion 1311b of the vibration generating part 1311 at one edge portion of the first cover member 1313. For example, the end portion (or the end or one side) of the first signal line 1323a may be electrically directly connected to at least a portion of the first electrode portion 1311b of the vibration sensing part 1311. For example, the end portion (or the end or one side) of the first signal line 1323a may be directly connected to or may directly come into contact with the first electrode portion 1311b of the vibration sensing part 1311. For example, the end portion of the first signal line 1323a may be electrically connected to the first electrode portion 1311b by a conductive double-sided tape. Accordingly, the first signal line 1323a may supply the first driving signal supplied from a driving circuitry to the first electrode portion 1311b of the vibration sensing part 1311.

The end portion (or the end or one side) of the second signal line 1323b may be electrically connected to the second electrode portion 1311c of the vibration sensing part 1311. For example, the end portion of the second signal line 1323b may be electrically connected to at least a portion of the second electrode portion 1311c of the vibration sensing part 1311 at one edge portion of the second cover member 1315. For example, the end portion of the second signal line 1323b may be electrically directly connected to at least a portion of the second electrode portion 1311c of the vibration sensing part 1311. For example, the end portion of the second signal line 1323b may be directly connected to or may directly come into contact with the second electrode portion 1311c of the vibration sensing part 1311. For example, the end portion of the second signal line 1323b may be electrically connected to the second electrode portion 1311c by a conductive double-sided tape. Accordingly, the second signal line 1323b may supply the second driving signal supplied from the driving circuitry to the second electrode portion 1311c of the vibration sensing part 1311.

The signal connection member 1320 according to one embodiment of the present specification may further include an insulating layer 1325.

The insulating layer 1325 may be disposed on the first surface of the protection member 1321 to cover each of the first signal line 1323a and the second signal line 1323b excluding an end portion (or one side) of the signal connection member 1320.

The end portion (or one side) of the signal connection member 1320 including an end portion (or one side) of the protection member 1321 and an end portion (or one side) 1325a of the insulating layer 1325 may be inserted (or accommodated) between the first cover member 1313 and the second cover member 1315 and may be fixed between the first cover member 1313 and the second cover member 1315 by the first adhesive layer 1317 and the second adhesive layer 1319. This may allow the end portion (or one side) of the first signal line 1323a to be maintained in a state of being electrically connected to the first electrode portion 1311b of the vibration sensing part 1311, and may allow the end portion (or one side) of the second signal line 1323b to be maintained in a state of being electrically connected to the second electrode portion 1311c of the vibration sensing part 1311. In addition, since the end portion (or one side) of the signal connection member 1320 may be inserted (or accommodated) and fixed between the vibration sensing part 1311 and the first cover member 1313, it is possible to prevent poor connection between the vibration sensing part 1311 and the signal connection member 1320 due to the movement of the signal connection member 1320.

In the signal connection member 1320 according to one embodiment of the present specification, the end portion (or one side) of the protection member 1321 and the end portion (or one side) 1325a of the insulating layer 1325 may be removed. For example, the end portion (or one side) of the first signal line 1323a and the end portion (or one side) of the second signal line 1323b may not be supported or covered by and exposed to the outside by the end portion (or one side) of the protection member 1321 and the end portion (or one side) 1325a of the insulating layer 1325. For example, the end portion (or one side) of each of the first signal line 1323a and the second signal line 1323b may protrude (or extend) from an end 1321e of the protection member 1321 or an end 1325e of the insulating layer 1325 to have a predetermined length. Accordingly, the end portion (or the end or one side) of each of the first signal line 1323a and the second signal line 1323b may be individually or independently bent.

The end portion (or one side) of the first signal line 1323a that is not supported by each of the end portion (or one side) of the protection member 1321 and the end portion (or one side) 1325a of the insulating layer 1325 may be directly connected to or may directly come into contact with the first electrode portion 1311b of the vibration sensing part 1311. The end portion (or one side) of the second signal line 1323b that is not supported by each of the end portion (or one side) of the protection member 1321 and the end portion (or one side) 1325a of the insulating layer 1325 may be directly connected to or may directly come into contact with the second electrode portion 1311c of the vibration sensing part 1311.

According to one embodiment of the present specification, a portion of the signal connection member 1320 or a portion of the protection member 1321 may be disposed or inserted (or accommodated) between the first cover member 1313 and the second cover member 1315, thereby integrating the signal connection member 1320 with the vibration sensing part 1311. This configuration may allow the vibration sensing part 1311 and the signal connection member 1320 to be formed as a single component, thereby achieving a uni-materialization effect.

According to one embodiment of the present specification, since the first signal line 1323a and the second signal line 1323b of the signal connection member 1320 are integrated with the vibration sensing part 1311, a soldering process for electrical connection between the vibration sensing part 1311 and the signal connection member 1320 is not required, thereby simplifying the structure and manufacturing process of the vibration sensing apparatus and improving the harmful process.

FIG. 17 is a view showing a vibration sensing part according to another embodiment of the present specification. For example, FIG. 17 shows another embodiment of the vibration sensing part described with reference to FIGS. 14 to 16.

Referring to FIGS. 15 and 17, the sensing portion 1311a according to another embodiment of the present specification may include a plurality of first portions 1311a1 and a plurality of second portions 1311a2. For example, the plurality of first portions 1311a1 and the plurality of second portions 1311a2 may be alternately and repeatedly disposed in the second direction (Y) (or the first direction (X)).

Each of the plurality of first portions 1311a1 may include an inorganic material having the piezoelectric effect (or piezoelectric properties). For example, each of the plurality of first portions 1311a1 may include at least one of a piezoelectric inorganic material and a piezoelectric organic material. For example, although each of the plurality of first portions 1311a1 may be an inorganic portion, an inorganic material portion, a piezoelectric portion, a piezoelectric material portion, or an electrically active portion, the embodiments of the present specification are not limited thereto.

According to one embodiment of the present specification, each of the plurality of first portions 1311a1 may have a width parallel to the second direction (Y) (or the first direction (X)) and extend in the first direction (X) (or the second direction (Y)). Since each of the plurality of first portions 1311a1 is substantially the same as the sensing portion 1311a described with reference to FIGS. 14 to 16, overlapping descriptions thereof may be omitted or simplified.

Each of the plurality of second portions 1311a2 may be disposed between the plurality of first portions 1311a1. For example, each of the plurality of first portions 1311a1 may be disposed between two adjacent second portions 1311a2 among the plurality of second portions 1311a2. Each of the plurality of second portions 1311a2 may have a width parallel to the second direction (Y) (or the first direction (X)) and extend in the first direction (X) (or the second direction (Y)). A width of the first portion 1311a1 may be the same as or different from a width of the second portion 1311a2. For example, the width of the first portion 1311a1 may be larger than the width of the second portion 1311a2. For example, although the first portion 1311a1 and the second portion 1311a2 may include a line shape or a stripe shape having the same size or different sizes, the embodiments of the present specification are not limited thereto.

Each of the plurality of second portions 1311a2 may be formed to fill a gap between two adjacent first portions 1311a1. Each of the plurality of second portions 1311a2 may be formed to fill the gap between the two adjacent first portions 1311a1 to be connected or adhered to a side surface of an adjacent first portion 1311a1. According to one embodiment of the present specification, the plurality of first portions 1311a1 and the plurality of second portions 1311a2 may be disposed (or arranged) parallel to each other on the same plane (or same layer). Therefore, the sensing portion 1311a may expand to a desired size or length by the side coupling (or connection) of the first portion 1311a1 and the second portion 1311a2.

According to one embodiment of the present specification, each of the plurality of second portions 1311a2 may absorb an impact applied to the first portion 1311a1, thereby increasing the durability of the first portion 1311a1 and providing flexibility to the sensing portion 1311a. Each of the plurality of second portions 1311a2 may include an organic material having soft properties. For example, although the plurality of second portions 1311a2 may be one or more of an epoxy-based polymer, an acrylic-based polymer, and a silicone-based polymer, the embodiments of the present specification are not limited thereto. For example, although each of the plurality of second portions 1311a2 may be an organic portion, an organic material portion, an adhesive portion, an elastic portion, a bending portion, a damping portion, or a soft portion, the embodiments of the present specification are not limited thereto.

The first surfaces of the plurality of first portions 1311a1 and the plurality of second portions 1311a2 may be commonly connected to the first electrode portion 1311b. The second surfaces of the plurality of first portions 1311a1 and the plurality of second portions 1311a2 may be commonly connected to the second electrode portion 1311c. For example, one or both of the first electrode portion 1311b and the second electrode portion 1311c may be formed as a pattern-shaped electrode corresponding only to the plurality of first portions 1311a1.

The sensing portion 1311a according to another embodiment of the present specification may have a shape of a single thin film by having the plurality of first portions 1311a1 and the plurality of second portions 1311a2 disposed (or connected) on the same plane. Therefore, the vibration sensing part 1311 or the vibration sensing member 1310 including the sensing portion 1311a according to another embodiment of the present specification may vibrate by the first portion 1311a1 having vibration characteristics and may be bent in a curved shape by the second portion 1311a2 having flexibility.

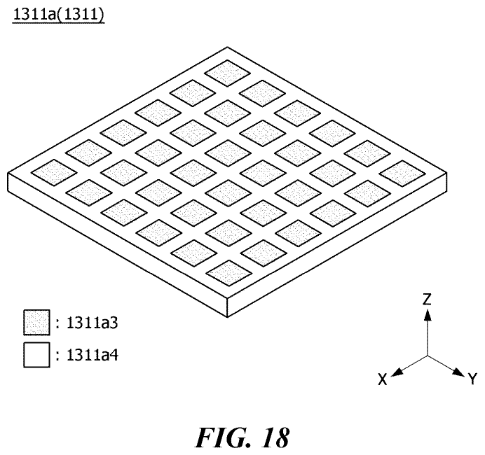

FIG. 18 is a diagram showing a vibration sensing part according to another embodiment of the present specification. For example, FIG. 18 shows still another embodiment of the vibration sensing part described with reference to FIGS. 14 to 16.

Referring to FIG. 15 and FIG. 18, the sensing portion 1311a according to still another embodiment of the present specification may include a plurality of first portions 1311a3, and a second portion 1311a4 disposed between the plurality of first portions 1311a3.

Each of the plurality of first portions 1311a3 may be disposed to be spaced apart from each other in each of the first direction (X) and the second direction (Y). For example, each of the plurality of first portions 1311a3 may have a hexahedral shape having the same size and may be disposed in a grid shape, but the embodiments of the present specification are not limited thereto. For example, each of the plurality of first portions 1311a3 may have a circular plate, an oval plate, or a polygonal plate shape having the same size, but the embodiments of the present specification are not limited thereto.

Since each of the plurality of first portions 1311a3 is substantially the same as the first portion 1311a1 described with reference to FIG. 17, overlapping descriptions thereof may be omitted or simplified.

The second portion 1311a4 may be disposed between the plurality of first portions 1311a3 in each of the first direction (X) and the second direction (Y). The second portion 1311a4 may be formed to fill a gap between two adjacent first portions 1311a3, to be adjacent to each of the plurality of first portions 1311a3, or to surround each of the plurality of first portions 1311a3 to be connected or adhered to an adjacent first portion 1311a3. Since the second portion 1311a4 is substantially the same as the second portion 1311a2 described with reference to FIG. 17, overlapping descriptions thereof may be omitted or simplified.

First surfaces of the plurality of first portions 1311a3 and the second portion 1311a4 may be commonly connected to the first electrode portion 1311b. Second surfaces of the plurality of first portions 1311a3 and the second portion 1311a4 may be commonly connected to the second electrode portion 1311c. According to another embodiment of the present specification, one or more of the first electrode portion 1311b and the second electrode portion 1311c may be formed in a pattern electrode shape corresponding only to the plurality of first portions 1311a3.

The sensing portion 1311a according to another embodiment of the present specification may have a shape of a single thin film by having the plurality of first portions 1311a3 and second portions 1311a4 disposed (or connected) on the same plane. Therefore, the vibration sensing part 1311 or the vibration sensing member 1310 including the sensing portion 1311a according to another embodiment of the present specification may vibrate by the first portion 1311a3 having vibration characteristics and may be bent in a curved shape by the second portion 1311a4 having flexibility.

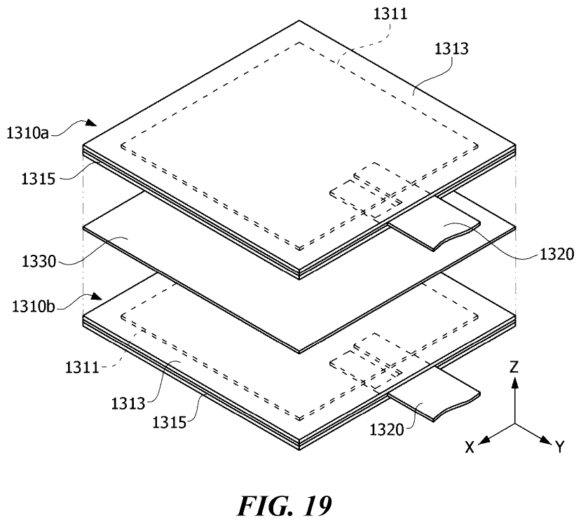

FIG. 19 is a view showing a vibration sensing apparatus according to another embodiment of the present specification.

Referring to FIG. 19, a vibration sensing apparatus according to another embodiment of the present specification may include a plurality of vibration sensing members 1310a and 1310b.

A first vibration sensing member 1310a and a second vibration sensing member 1310b may overlap or may be stacked to displace (or drive or vibrate) in the same direction in order to maximize the amplitude displacement of the vibration sensing apparatus and/or the amplitude displacement of the vibration members. For example, the first vibration sensing member 1310a and the second vibration sensing member 1310b may have substantially the same size, but the embodiments of the present disclosure are not limited thereto. Therefore, the first vibration sensing member 1310a and the second vibration sensing member 1310b may maximize the amplitude displacement of the vibration sensing apparatus and/or the amplitude displacement of the vibration member.

According to one embodiment of the present disclosure, one of the first vibration sensing member 1310a or the second vibration sensing member 1310b may be connected or coupled to the vibration member via an adhesive member. For example, the first vibration sensing member 1310a may be connected or coupled to the vibration member via the adhesive member.

Each of the first vibration sensing member 1310a and the second vibration sensing member 1310b is the same as or substantially the same as the vibration sensing member 1310 described with reference to FIGS. 14 to 18 and is therefore designated by the same reference numerals, and overlapping descriptions thereof may be omitted or simplified.

The vibration sensing apparatus according to another embodiment of the present specification may further include an intermediate member 1330.

The intermediate member 1330 may be disposed or connected between the first vibration sensing member 1310a and the second vibration sensing member 1310b. For example, the intermediate member 1330 may be disposed or connected between the second cover member 1315 of the first vibration sensing member 1310a and the first cover member 1313 of the second vibration sensing member 1310b. For example, the intermediate member 1330 may be an adhesive member or a connection member, but the embodiments of the present specification are not limited thereto.

The intermediate member 1330 according to the embodiment of the present specification may be made of a material including an adhesive layer having excellent adhersion strength or adhesive strength to each of the first vibration sensing member 1310a and the second vibration sensing member 1310b. For example, the intermediate member 1330 may include a foam pad, a double-sided tape, a double-sided foam tape, a double-sided pad, a double-sided foam pad, an adhesive, or the like, but the embodiments of the present specification are not limited thereto. For example, an adhesive layer of the intermediate member 1330 may include an epoxy, acrylic, silicone, or urethane, but the embodiments of the present specification are not limited thereto. For example, the adhesive layer of the intermediate member 1330 may include a urethane-based material (or material) having relatively soft properties. Therefore, the vibration loss due to the displacement interference between the first vibration sensing member 1310a and the second vibration sensing member 1310b may be minimized, or each of the first vibration sensing member 1310a and the second vibration sensing member 1310b may be freely displaced (or vibrated or driven).

The vibration sensing apparatus according to another embodiment of the present specification may maximize or increase the displacement or amplitude displacement by including the first vibration sensing member 1310a and the second vibration sensing member 1310b that are stacked (or overlapped or superimposed) to vibrate (or displace or drive) in the same direction. Therefore, it is possible to maximize or increase the displacement (or a bending force or driving force) or amplitude displacement of the vibration member.

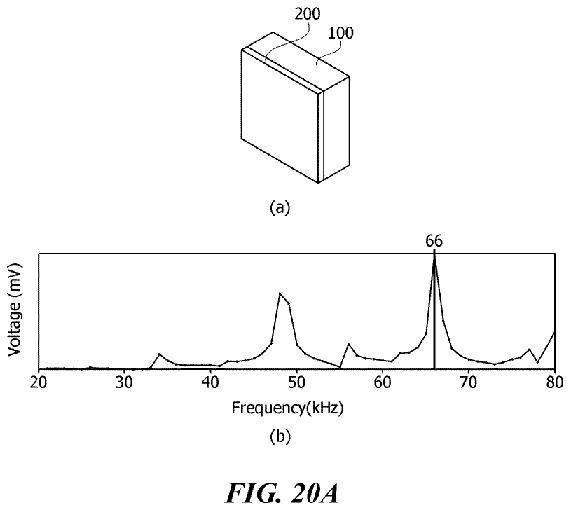

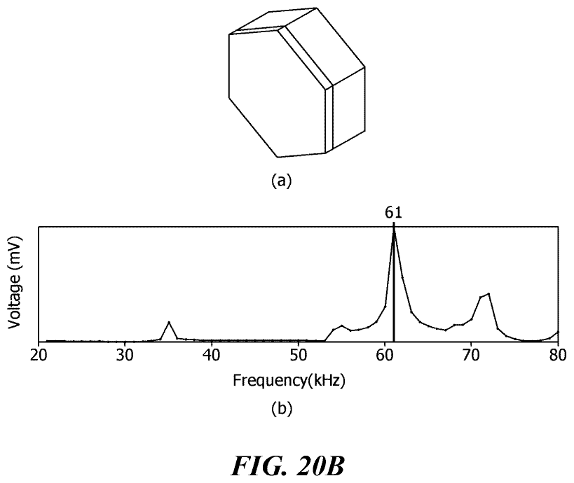

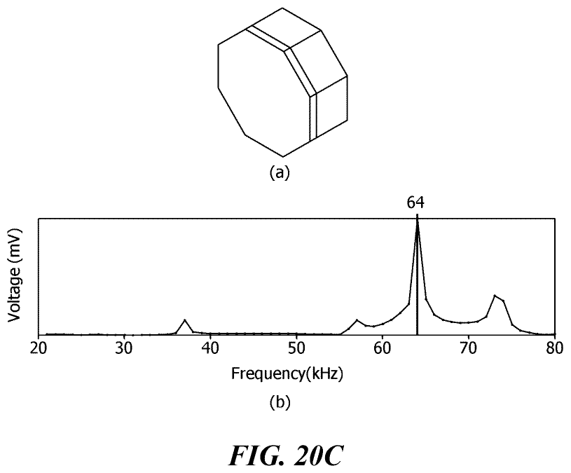

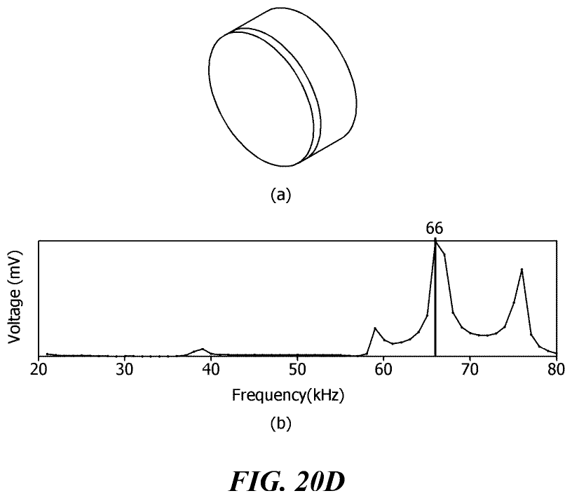

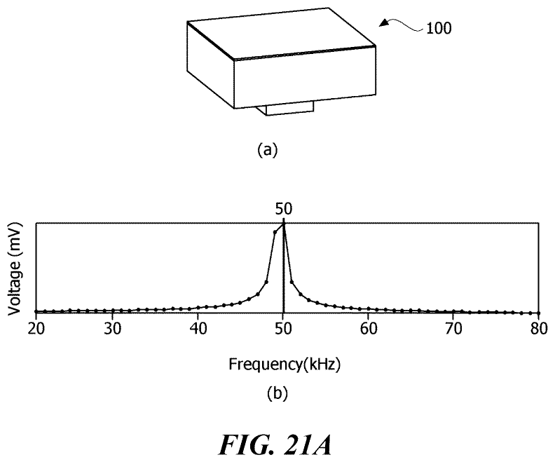

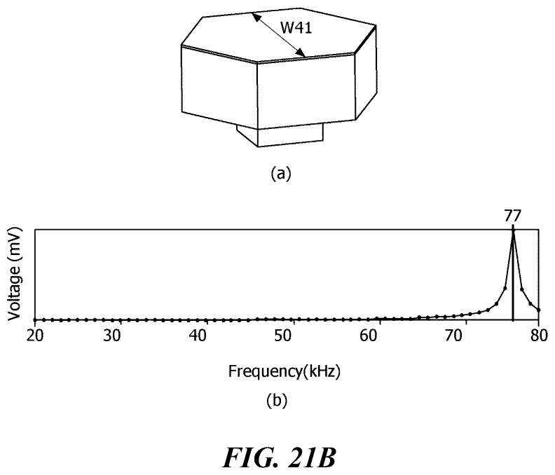

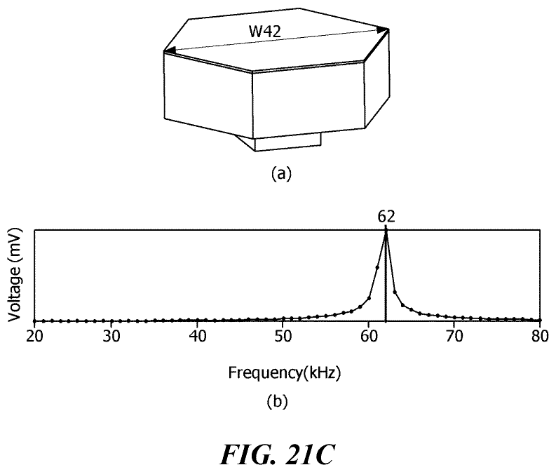

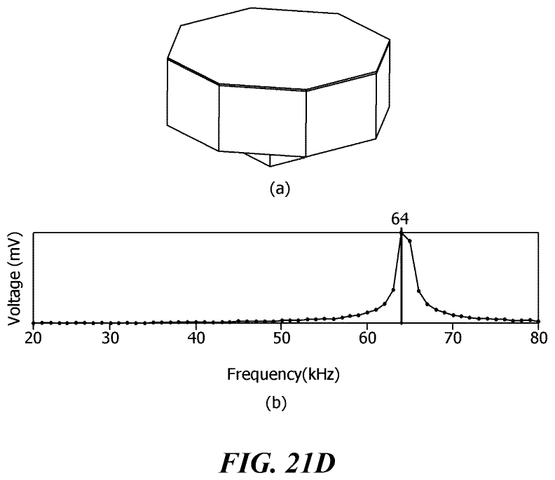

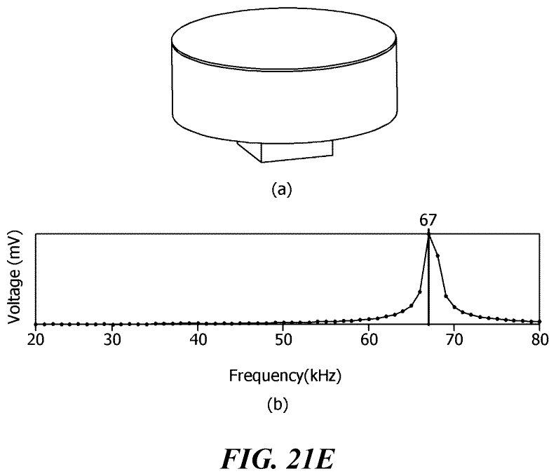

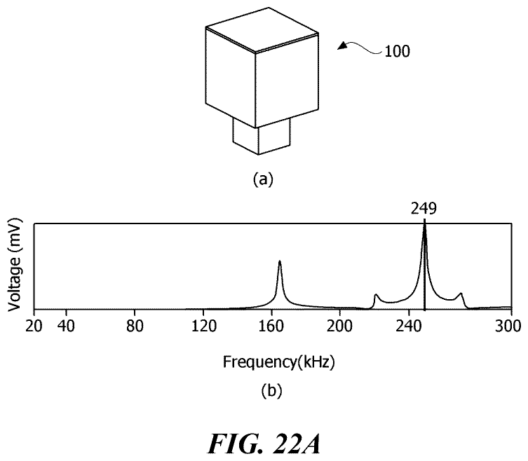

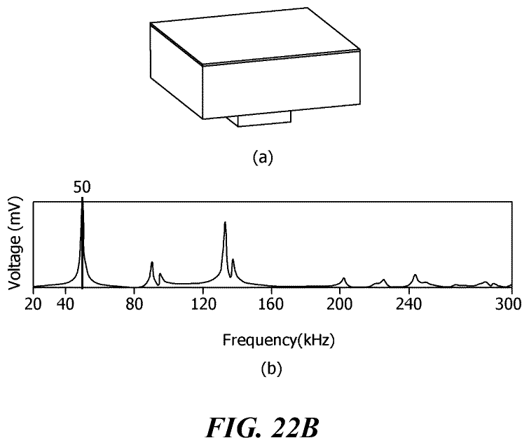

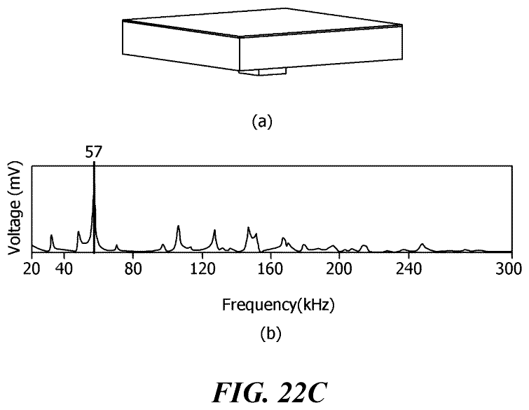

FIGS. 20A to 20D are views showing the sensing voltage characteristics according to a change in the shape of the base member of the present specification. FIGS. 21A to 21E are views showing the sensing voltage characteristics according to a change in the shape of the base member in a structure in which the vibration transmission member is omitted. FIGS. 22A to 22C are views showing the sensing voltage characteristics according to a change in the area of the base member of the present specification.

The shapes of the base member 100 and the vibration transmission member 200 may have a square shape, a hexagonal shape, an octagonal shape, and a circular shape, but the embodiments of the present specification are not limited thereto. In FIG. 20A to 22C, the horizontal axis represents the frequency (kHz) and the vertical axis represents the sensing voltage (mV).

Referring to FIG. 20A, the largest sensing voltage of 631.19 mV was output in the frequency region of 66 kHz when the base member 100 and the vibration transmission member 200 were square in shape. The frequency region of 66 kHz, where the highest sensing voltage is output, may correspond to a resonant frequency of the base member 100 and/or the vibration transmission member 200.

Referring to FIG. 20B, the sensing voltage of 1151.2 mV was output in the frequency region of 61 kHz when the base member 100 and the vibration transmission member 200 were hexagonal in shape. Therefore, it may be confirmed that the resonant frequency became lowered when the shape is changed from a rectangular shape to a hexagonal shape.

Referring to FIG. 20C, the sensing voltage of 1588.9 mV was output in the frequency region of 64 kHz when the base member 100 and the vibration transmission member 200 were octagonal in shape.

Referring to FIG. 20D, the sensing voltage of 1281.3 mV was output in the frequency region of 66 kHz when the base member 100 and the vibration transmission member 200 were rectangular in shape.

According to the embodiments of the present specification, it may be seen that the resonant frequency and the sensing sensitivity may be adjusted by changing the shapes of the base member 100 and/or the vibration transmission member 200.

Referring to FIGS. 21A to 21E, it may be confirmed that in the case of a sensor in which a sensing element is disposed on the base member 100 without a vibration transmission member, the voltage level varies according to the shape of the base member 100.

Referring to FIG. 21A, a sensing voltage of 638.91 mV was output in the frequency region of 50 kHz for the square-shaped base member 100. Referring to FIG. 21B, a sensing voltage of 1389.6 mV was output in the frequency region of 77 kHz for a hexagonal-shaped base member 100 with having a length of a short side W41 of 30 mm. Referring to FIG. 21C, a sensing voltage of 1031.2 mV was output in the frequency region of 62 kHz for a hexagonal-shaped base member 100 having a length of a long side W42 of 30 mm. Referring to FIG. 21D, a sensing voltage of 838.56 mV was output in the frequency region of 64 kHz for the octagonal-shaped base member 100. Referring to FIG. 21E, a sensing voltage of 1101.4 mV was output in the frequency region of 67 kHz for the circular-shaped base member 100. The shape of the base member 100 in FIGS. 21A to 21E are not limited to the contents of the present specification.

Referring to FIGS. 22A to 22C, it may be seen that the resonant frequency varies according to the area of the base member 100. Referring to FIG. 22A, a sensing voltage of 1783.0 mV was output in the frequency region of 249 kHz for the base member 100 having a side length of 10 mm. Referring to FIG. 22B, a sensing voltage of 638.91 mV was output in the frequency region of 50 kHz for the base member 100 having a side length of 30 mm. It may be seen that when the size of the base member 100 is small, the highest voltage value occurs in the high frequency due to the small force-receiving area, and when the size of the base member is large, although the resonant frequency appears in the low frequency band, the voltage value is relatively low. The sizes of the base member 100 in FIGS. 22A to 22C are not limited to the contents of the present specification.

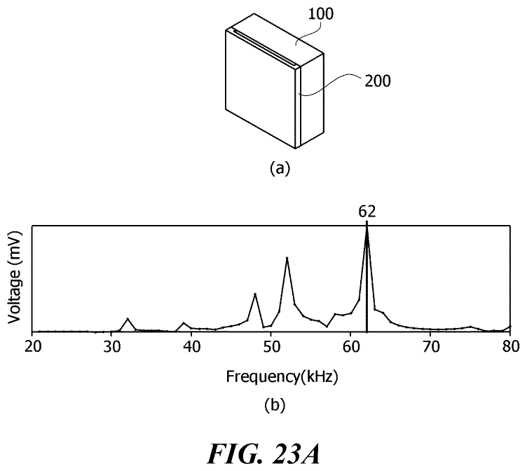

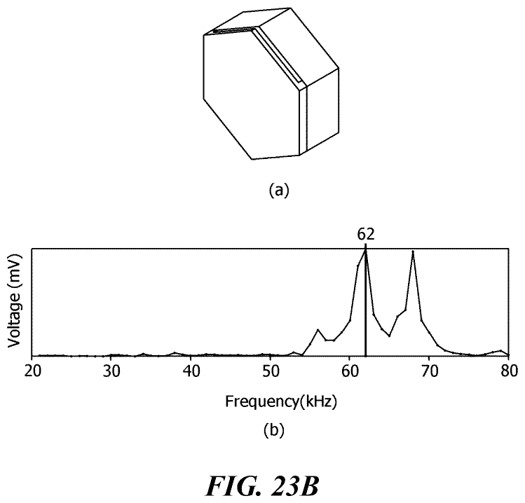

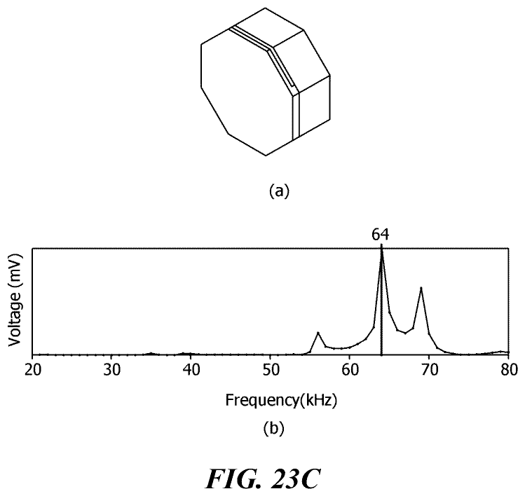

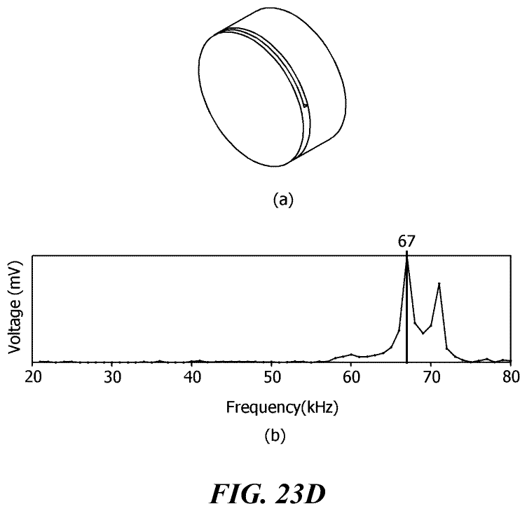

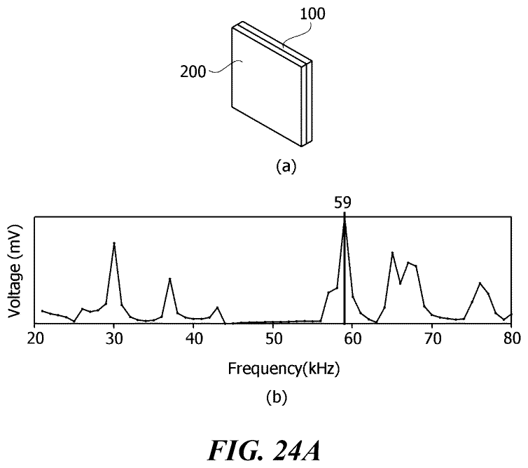

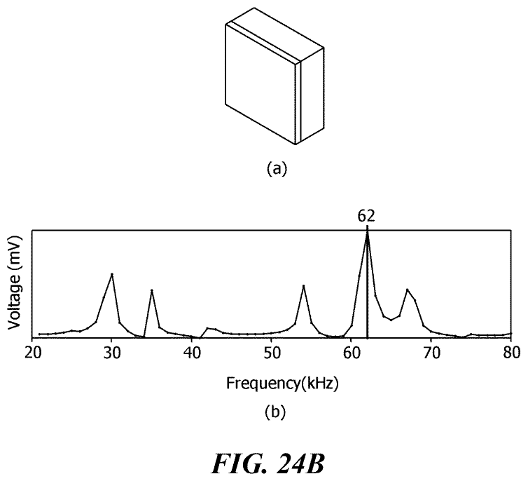

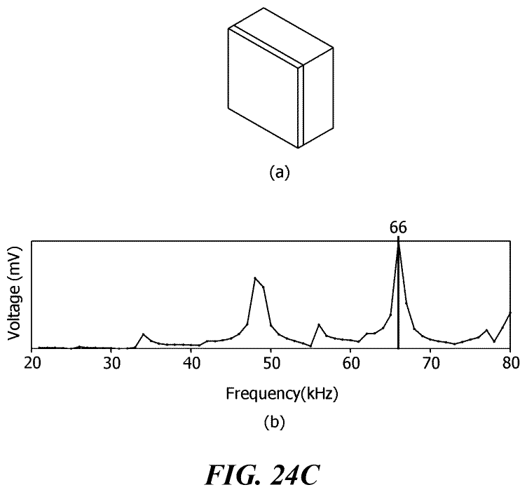

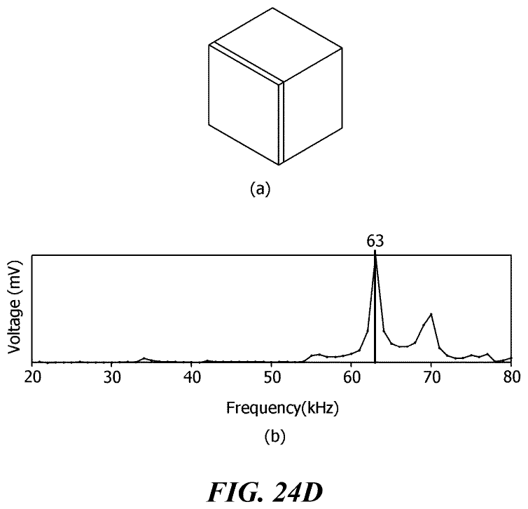

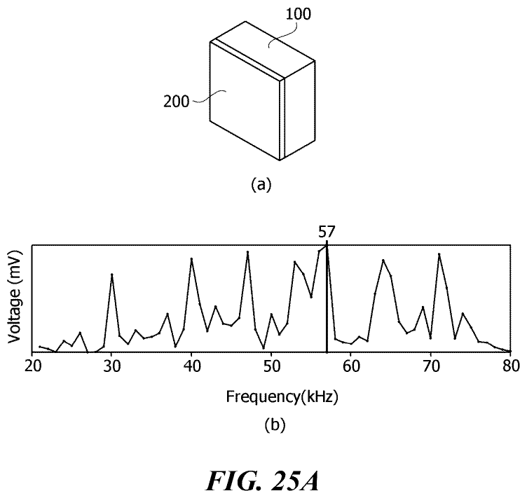

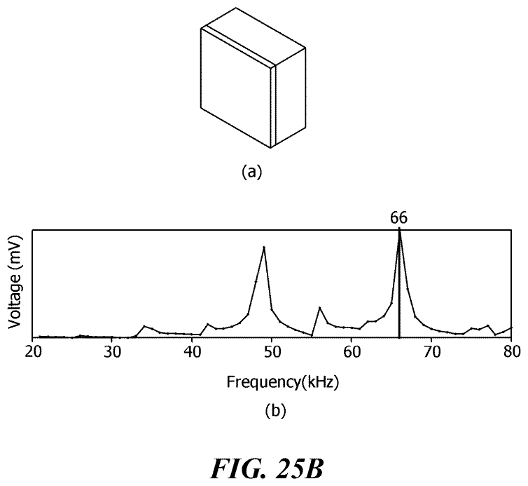

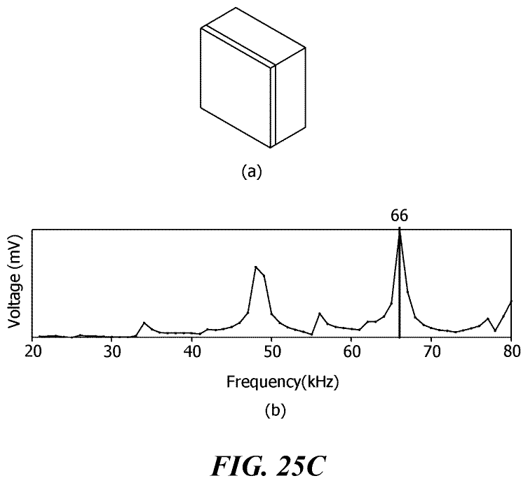

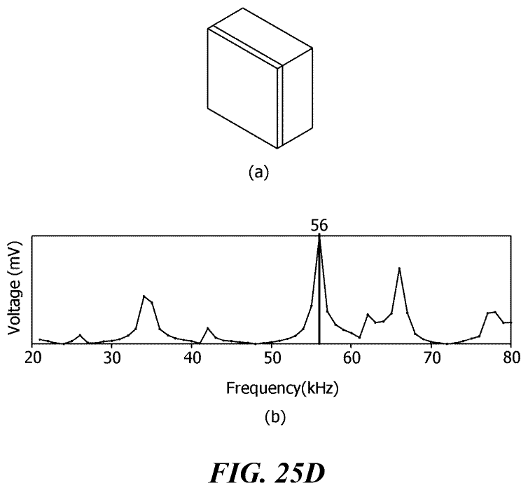

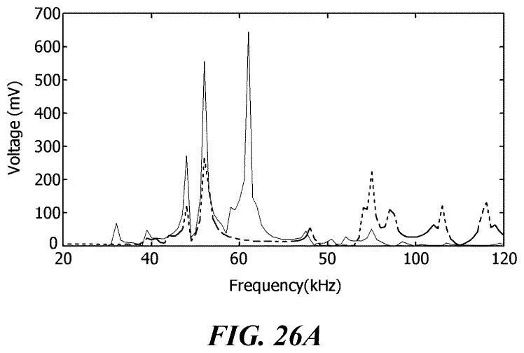

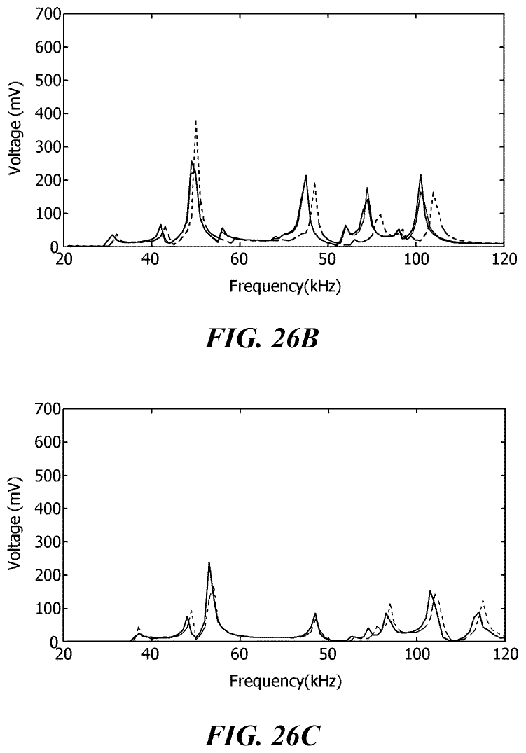

FIGS. 23A to 23D are views showing the sensing voltage characteristics according to the shapes of the sensing elements and the vibration transmission members of the present specification. FIGS. 24A to 24D are views showing the sensing voltage characteristics according to a change in the thickness of the base member of the present specification. FIGS. 25A to 25D are views showing the sensing voltage characteristics according to a change in strength of the base member of the present specification. FIGS. 26A to 26C are views showing the sensing voltage characteristics according to a change in the material of the vibration transmission member of the present specification. In FIGS. 23A to 26C, the horizontal axis represents the frequency (kHz) and the vertical axis represents the sensing voltage (mV).

According to the embodiments, the resonant frequency may be adjusted by changing the shapes of the sensing element 300 and the vibration transmission member 200.

Referring to FIG. 23A, a sensing voltage value of 677.57 mV was output in the frequency region of 62 kHz when the sensing element 300 and the vibration transmission member 200 were rectangular in shape. Referring to FIG. 23B, a sensing voltage value of 679.65 mV was output in the frequency region of 62 kHz when the sensing element 300 and the vibration transmission member 200 were hexagonal in shape. Referring to FIG. 23C, a sensing voltage value of 1027.1 mV was output in the frequency region of 64 kHz when the sensing element 300 and the vibration transmission member 200 were octagonal in shape. Referring to FIG. 23D, a sensing voltage value of 1361.6 mV was output in the frequency region of 67 kHz when the sensing element 300 and the vibration transmission member 200 have a circular shape. According to the embodiment, it may be seen that when the shapes of the sensing element 300 and the vibration transmission member 200 are adjusted to a polygonal shape, the main resonant frequency becomes larger and the sensing voltage increases.

Referring to FIG. 24A, when the thickness of the base member 100 is 2 mm, a sensing voltage value of 733.28 mV is output in the frequency region of 59 kHz, and sub-resonances occurred in the low frequency regions of 30 kHz and 37 kHz.

Referring to FIG. 24B, when the thickness of the base member 100 is 5 mm, a sensing voltage value of 857.38 mV is output in the frequency region of 62 kHz, and sub-resonances occurred in the low frequency ranges of 30 kHz and 35 kHz.

Referring to FIG. 24C, when the thickness of the base member 100 is 10 mm, a sensing voltage value of 631.19 mV was output in the frequency region of 66 kHz, and sub-resonances occurred in the low frequency ranges of 48 kHz and 56 kHz.

Referring to FIG. 24D, it may be confirmed that when the thickness of the base member 100 is 20 mm, a sensing voltage value of 890.87 mV was output in the frequency region of 63 kHz, and there is no sub-resonance in the low frequency regions below 60 kHz. The thicknesses of the base member 100 in FIGS. 24A to 24D are not limited to the contents of the present specification.

According to the embodiment, it may be seen that as the thickness of the base member 100 increases, the resonance in the low frequency region disappears and a resonant frequency occurs in the 60 kHz band.

Referring to FIG. 25A, when the base member 100 is made of polycarbonate (PC) material, a sensing voltage value of 977.01 mV was output in the frequency region of 57 kHz. Referring to FIG. 25B, when the base member 100 is made of aluminum (Al) material, a sensing voltage value of 631.19 mV was output in the frequency region of 66 kHz. Referring to FIG. 25C, when the base member 100 is made of iron (Fe) material, a sensing voltage value of 243.40 mV was output in the frequency region of 66 kHz. Referring to FIG. 25D, when the base member 100 was a rigid material having an elastic modulus of at least 200,000 Gpa, a sensing voltage value of 23.527 mV was output in the frequency region of 56 kHz. According to the embodiment, it may be seen that the greater the stiffness of the base member 100, the lower the voltage value at the resonant frequency. The materials of the base member 100 in FIGS. 25A to 25D are not limited to the contents of the present specification.

FIGS. 26A to 26C are views showing the sensing voltage characteristics according to a change in the material of the vibration transmission member of the present specification.

Referring to FIG. 26A, the vibration transmission member 200 may have a resonant frequency in a high frequency band of about 60 kHz or more when it is made of an aluminum (Al) material having a relatively high specific stiffness compared to when it is made of polycarbonate (PC) material having a relatively low specific stiffness. When it is made of polycarbonate (PC) material, it may have a resonant frequency at a relatively low frequency.

Referring to FIG. 26B, when the vibration transmission member 200 is made of a copper alloy series such as brass, bronze, or copper, it may have a resonant frequency of relatively constant magnitude in the frequency regions of 30 kHz to 100 kHz. Therefore, it may be seen that sensing may be carried out widely in the frequency regions of 30 kHz to 100 kHz.

Referring to FIG. 26C, when the vibration transmission member 200 is made of stainless steel and structural steel, multiple resonant frequencies may occur in the high frequency band of 60 kHz or more. The materials of the vibration transmission member 200 in FIGS. 26A to 26C are not limited to the contents of the present specification.

According to the embodiment, the base member 100 and the vibration transmission member 200 may have a larger resonant frequency as their shapes change from a rectangular shape to a polygonal and a circular shape. While the base member 100 may have little direct influence on frequency, its increased stiffness may result in a lower sensing voltage. Accordingly, the base member 100 may be formed of a material with lower strength. The base member 100 may be selected from a material with lower strength than the vibration transmission member 200. The higher the specific strength (Young's modulus/density) of the material, the higher the frequency at which the vibration transmission member 200 may occur.

As shown in Table 1 below, in order to adjust the resonant frequency to a low frequency band, the base member 100 and/or the vibration transmission member 200 may be configured to have a rectangular shape. In addition, the specific strength of the vibration transmission member 200 may be configured to be lower than that of the base member 100 in order to lower the frequency. For example, the base member 100 may be made of a copper alloy and the vibration transmission member 200 may be made of polycarbonate (PC), but the embodiments of the present specification are not limited thereto.

In order to adjust the resonant frequency to the mid-frequency band, the base member 100 and/or the vibration transmission member 200 may be configured to have a hexagonal or octagonal shape. The specific strength of the vibration transmission member 200 may be configured to be the same as that of the base member 100. For example, the vibration transmission member 200 and the base member 100 may be made of a copper alloy, but the embodiments of the present specification are not limited thereto. The mid-frequency may be 500 Hz or more, or 1 kHz or less, but the embodiments of the present specification are not limited thereto.

In order to adjust the resonant frequency to a high frequency band, the base member 100 and/or the vibration transmission member 200 may be configured to have a circular shape. The materials of the base member 100 and the material of the vibration transmission member 200 may be formed differently from each other. For example, the vibration transmission member 200 may be formed to have a higher specific stiffness than the base member 100. For example, the vibration transmission member 200 may be formed of aluminum or stainless steel, and the base member 100 may be formed of a copper alloy, but the embodiments of the present specification are not limited thereto.

For example, three vibration transmission members 200 may be arranged to have full range of low to high frequency regions. The base member 100 may be made of a copper alloy. A first vibration transmission member 200, which has a main resonant frequency in the low frequency range, may be formed of polycarbonate, which has a lower specific stiffness than the base member 100. A second vibration transmission member 200, which has a main resonant frequency in the mid-frequency range, may be formed of a copper alloy having the same specific stiffness as the base member 100. A third vibration transmission member 200, which has a main resonant frequency in the high frequency range, may be formed of aluminum or stainless steel having a higher specific stiffness than the base member 100. According to the embodiment, the material and/or the shape of the vibration transmission member 200 may be the same as or different from that of the base member 100.

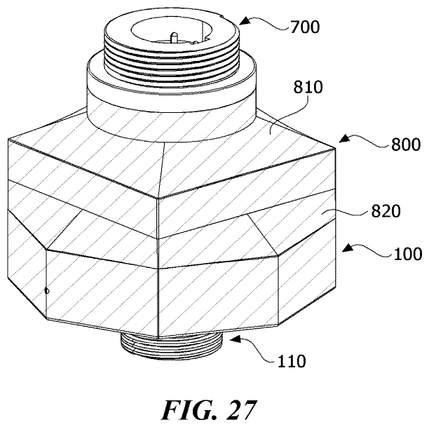

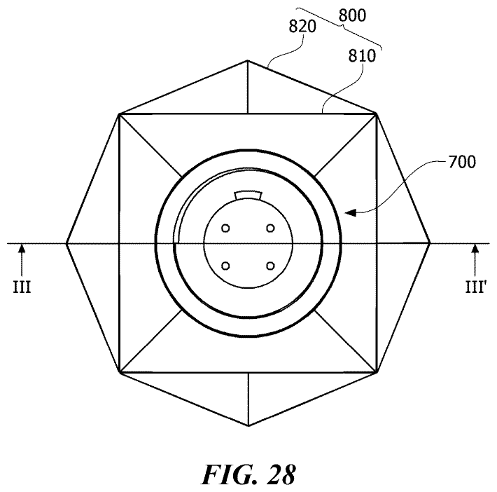

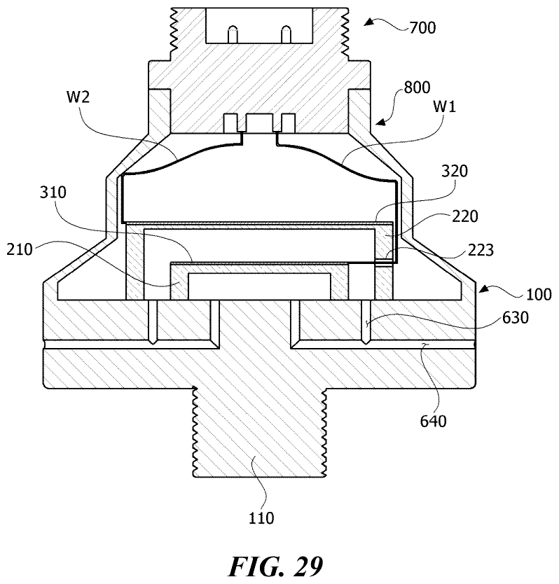

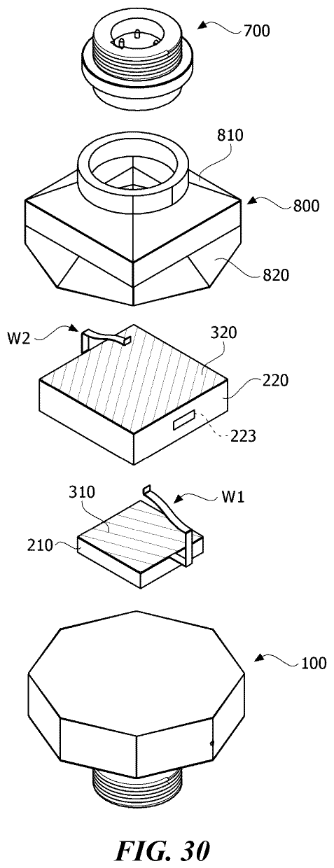

FIG. 27 is a perspective view showing a vibration sensing apparatus according to one embodiment of the present specification. FIG. 28 is a plan view showing the vibration sensing apparatus according to one embodiment of the present specification. FIG. 29 is a cross-sectional view along the direction of line III-III′ in FIG. 28. And FIG. 30 is an exploded perspective view showing the vibration sensing apparatus according to one embodiment of the present specification.

Referring to FIGS. 27 to 30, the vibration sensing apparatus according to the embodiment may include a housing 800, a first wire W1 connected to a first sensing element 310, a second wire W2 connected to a second sensing element 320, and a connector 700.

The housing 800 may be coupled to the base member 100 to block the vibration transmission member 200 and the sensing element 300 from the outside. The housing 800 may include a first housing 810 having a first polygonal shape and a second housing 820 having a second polygonal shape, but the embodiments of the present specification are not limited thereto. The first polygonal shape and the second polygonal shape may be different. For example, the first polygonal shape may be a rectangular shape and the second polygonal shape may be a hexagonal shape corresponding to the base member 100. However, the embodiments of the present specification are not limited thereto. For example, the first housing 810 and the second housing 820 may have the same shape.

A first vibration transmission member 210 may be disposed on the base member 100, and a second vibration transmission member 220 may be disposed on the first vibration transmission member 210. A fastening part 110 may be disposed at a lower portion of the base member 100, but the embodiments of the present specification are not limited thereto. A third vent hole 630 and a fourth vent hole 640 may be configured on the interior of the base member 100, but the embodiments of the present specification are not limited thereto. A third vent hole 630 may be connected to the first vibration transmission member 210. The third vent hole 630 may be connected to the outside via a fourth vent hole 640. The connector 700 may be coupled to the housing 800 and a connection pin may be disposed inside the housing 800. The connector 700 may be connected to with an external device. The external device may be a variety of analytical equipment that may read voltage values from the sensing element 300 and analyze the vibration pattern of the measurement target.

The first wire W1 may have one side connected to the first sensing element 310 and the other side connected to the connector 700. The second wire W2 may have one side be connected to the second sensing element 320 and the other side connected to the connector 700. The first wire W1 may be exposed through a communication hole 223 formed in the side surface of the second vibration transmission member 220 to be connected to the connector 700. However, the embodiments of the present specification are not limited thereto.

The vibration sensing apparatus according to the embodiment of the present specification may be described as follows.

The vibration sensing apparatus according to an embodiment of the present specification may include a base member, a vibration transmission member disposed on the base member, and a sensing element disposed on the vibration transmission member. The vibration transmission member may transmit an external vibration signal to the sensing element.

According to various embodiments of the present specification, the base member may include a first transmission portion in which the sensing element is disposed and a second transmission portion that forms a space between the first transmission portion and the base member.

According to various embodiments of the present specification, the resonant frequency of the vibration transmission member may be matched to the frequency of the external vibration signal.

According to various embodiments of the present specification, the second transmission portion may surround an edge of the first transmission portion.

According to various embodiments of the present specification, the second transmission portion may be disposed on a partial area of the edge of the first transmission portion.

According to various embodiments of the present specification, the thickness of the base member may be greater than the thickness of the vibration transmission member.

According to various embodiments of the present specification, a material of the vibration transmission member may be different from that of the base member.

According to various embodiments of the present specification, a planar shape of the base member and a planar shape of the vibration transmission member may be different.

According to various embodiments of the present specification, the vibration sensing apparatus may further include a vent hole connected to the space.

According to various embodiments of the present specification, a coupling member may be disposed between the vibration transmission member and the base member.

According to various embodiments of the present specification, the coupling member may include a plurality of openings.

According to various embodiments of the present specification, the vibration transmission member may include a first vibration transmission member disposed on the base member and a second vibration transmission member disposed on the first vibration transmission member. The sensing element may include a first sensing element disposed on the first vibration transmission member, and a second sensing element disposed on the second vibration transmission member.

According to various embodiments of the present specification, the first vibration transmission member and the second vibration transmission member may have different resonant frequencies.

According to various embodiments of the present specification, the first vibration transmission member may include a first-first transmission portion in which the first sensing element is disposed and a first-second transmission portion that forms a first space for spacing the first transmission portion from the base member. The second vibration transmission member may include a second-first transmission portion in which the second sensing element is disposed and a second-second transmission portion that forms a second space for spacing the second-first transmission portion from the base member. The first vibration transmission member and the first sensing element may be disposed in the second space.

According to various embodiments of the present specification, the vibration sensing apparatus may further include a first vent hole disposed in the first-second transmission portion, and a second vent hole disposed in the second-second transmission portions.

According to various embodiments of the present specification, the vibration sensing apparatus may further include a third vent hole connecting the first and second spaces. The third vent hole may be formed in the base member.

According to various embodiments of the present specification, the vibration sensing apparatus may further include a fourth vent hole which has one side connected to the third vent hole and the other side exposed to the outside. The fourth vent hole may be formed in the base member.

According to various embodiments of the present specification, the vibration sensing apparatus may further include a fastening part for coupling the base member to a measurement target.

According to various embodiments of the present specification, the vibration sensing apparatus may further include a housing coupled to the base member and configured to house the vibration transmission member and the sensing element, a first wire coupled to the first sensing element, a second wire coupled to the second sensing element, and a connector coupled to the housing and connected to the first wire and the second wire.

According to various embodiments of the present specification, the first wire may be connected to the connector through a communication hole formed in a side surface of the second vibration transmission member.

According to various embodiments of the present disclosure, the sensing element may include a sensing portion including a piezoelectric material, a first electrode portion on a first surface of the sensing portion, and a second electrode portion on a second surface that is different from the first surface of the sensing portion.

The vibration sensing apparatus according to various embodiments of the present specification may be applied to or included in devices. The devices according to the embodiment of the present specification may be applicable to or included in a mobile device, a video phone, a smart watch, a watch phone, a wearable apparatus, a foldable apparatus, a rollable apparatus, a bendable apparatus, a flexible apparatus, a curved apparatus, a sliding apparatus, a variable apparatus, an electronic notebook, an e-book, a portable multimedia player (PMP), a personal digital assistant (PDA), an MP3 player, a mobile medical device, a desktop PC, a laptop PC, a netbook computer, a workstation, a navigation device, an in-vehicle navigation device, an in-vehicle display device, an in-vehicle device, theater device, theater display device, a television, a wallpaper device, a signage device, a gaming device, a laptop, a monitor, a camera, a camcorder, and a home appliance. In addition, the vibration sensing apparatus according to various embodiments of the present specification may be applicable to or included in an organic light-emitting lighting device or an inorganic light-emitting lighting device. When the vibration sensing apparatus is applied to the lighting device, the lighting devices may serve as a lighting and a sensing device. In addition, when the vibration sensing apparatus according to one or more embodiments of the present specification is applied to a mobile device or the like, the vibration sensing apparatus may be a sensing apparatus, a receiver, and a haptic apparatus, but the embodiments of the present specification are not limited thereto.

### DESCRIPTION OF REFERENCE NUMERALS

| | |
|---|---|
| 100: Base member | 110: Fastening part |
| 200: Vibration transmission member | 201: First transmission portion |
| 202: Second transmission portion | 210: First vibration |
| | transmission member |
| 220: Second vibration | |
| transmission member | |
| 300: Sensing element | 310: First sensing element |
| 320: Second sensing element | 400: Space |

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vibration sensing apparatus comprising:
a base member;
a vibration transmission member disposed on the base member; and
a sensing element disposed on the vibration transmission member,
wherein the vibration transmission member is configured to transmit an external vibration signal to the sensing element.

2. The vibration sensing apparatus of claim 1, wherein the vibration transmission member includes:
a first transmission portion, the sensing element disposed in the first transmission portion;
a second transmission portion between the first transmission portion and the base member; and
a space between the base member and the second transmission portion.

3. The vibration sensing apparatus of claim 1, wherein a resonant frequency of the vibration transmission member is matched to a frequency of the external vibration signal.

4. The vibration sensing apparatus of claim 2, wherein the second transmission portion surrounds an edge of the first transmission portion.

5. The vibration sensing apparatus of claim 2, wherein the second transmission portion is disposed at a partial area of an edge of the first transmission portion.

6. The vibration sensing apparatus of claim 1, wherein a thickness of the base member is greater than a thickness of the vibration transmission member.

7. The vibration sensing apparatus of claim 1, wherein a material of the vibration transmission member is different from a material of the base member.

8. The vibration sensing apparatus of claim 1, wherein the base member and the vibration transmission member have different planar shapes.

9. The vibration sensing apparatus of claim 2, further comprising:
a vent hole connected to the space.

10. The vibration sensing apparatus of claim 1, further comprising:
a coupling member disposed between the vibration transmission member and the base member.

11. The vibration sensing apparatus of claim 10, wherein the coupling member includes a plurality of openings.

12. The vibration sensing apparatus of claim 2, wherein:
the vibration transmission member includes a first vibration transmission member disposed on the base member and a second vibration transmission member disposed on the first vibration transmission member, and
the sensing element includes a first sensing element disposed on the first vibration transmission member and a second sensing element disposed on the second vibration transmission member.

13. The vibration sensing apparatus of claim 12, wherein the first vibration transmission member and the second vibration transmission member have different resonant frequencies.

14. The vibration sensing apparatus of claim 12, wherein:
the first vibration transmission member includes a first portion and a second portion, the first sensing element disposed in the first portion and the second portion defines a first space between the first portion and the base member,
the second vibration transmission member includes a first portion and a second portion, the second sensing element disposed in the first portion of the second vibration transmission member and the second portion defines a second space between the second portion of the second vibration transmission member and the base member, and
the first vibration transmission member and the first sensing element are disposed in the second space.

15. The vibration sensing apparatus of claim 14, further comprising:
a first vent hole disposed in the second portion of the first vibration transmission member; and
a second vent hole disposed in the second portion of the second vibration transmission member.

16. The vibration sensing apparatus of claim 14, further comprising:
a third vent hole configured to connect the first space and the second space,
wherein the third vent hole is in the base member.

17. The vibration sensing apparatus of claim 16, further comprising:
a fourth vent hole having a first side connected to the third vent hole and a second side exposed to the outside,
wherein the fourth vent hole is in the base member.

18. The vibration sensing apparatus of claim 1, further comprising:
a fastening part configured to couple the base member to a measurement target.

19. The vibration sensing apparatus of claim 12, further comprising:
a housing coupled to the base member and configured to house the vibration transmission member and the sensing element;
a first wire connected to the first sensing element;
a second wire connected to the second sensing element; and
a connector coupled to the housing and connected to the first wire and the second wire.

20. The vibration sensing apparatus of claim 19, wherein the first wire is connected to the connector through a communication hole formed in a side surface of the second vibration transmission member.

21. The vibration sensing apparatus of claim 1, wherein the sensing element includes:
a sensing portion including a piezoelectric material;
a first electrode portion on a first surface of the sensing portion; and
a second electrode portion on a second surface that is different from the first surface of the sensing portion.
